(19) United States
(12) Patent Application Publication
(10) Pub. No.: US 2024/0340616 A1
(43) Pub. Date: Oct. 10, 2024

(54) Managing Notifications for Multicast and Broadcast Services

(71) Applicant: GOOGLE LLC, Mountain View, CA (US)

(72) Inventor: Chih-Hsiang Wu, Taoyuan City (TW)

(21) Appl. No.: 18/293,958

(22) PCT Filed: Aug. 4, 2022
(86) PCT No.: PCT/US22/39402

§ 371 Date: Jan. 31, 2024

Related U.S. Application Data
(60) Provisional application No. 63/203,993, filed on Aug. 5, 2021.

(51) Int. Cl. H04W 4/06; H04W 68/02

(52) U.S. Cl. CPC H04W 4/06; H04W 68/025

(57) ABSTRACT

A central unit (CU) and distributed unit (DU) of a distributed base station (BS) in a radio access network (RAN) can implement a method for managing paging of multicast and broadcast services (MBS). The method includes: receiving, from a core network (CN), an identifier for an MBS session and an identifier for a user equipment (UE); transmitting, to the DU, one or more messages, including the identifier for the MBS session and the identifier for the UE; transmitting, to the DU, one or more parameters for paging associated with the MBS session; and transmitting, to the DU, one or more MBS data packets to be broadcast to the UE in accordance with the one or more parameters.

### FIELD OF THE DISCLOSURE

This disclosure relates to wireless communications and, more particularly, to paging UEs for one or more multicast and/or broadcast services (MBS).

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides services for signaling radio bearers (SRBs) to the Radio Resource Control (RRC) sublayer. The PDCP sublayer also provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

UEs communicating with base stations operating according to 5G, 6G, or later-generation requirements may support a 100 MHz bandwidth in a frequency range 1 (FR1) and a 400 MHz bandwidth in a frequency range 2 (FR2). Due to the relatively wide bandwidth of a typical carrier, such a base station can provide multicast and/or broadcast services (MBS) to UEs used in many content delivery applications, such as transparent IPv4/IPv6 multicast delivery, IPTV, software delivery over wireless, group communications, IoT applications, V2X applications, and emergency messages related to public safety.

To provide multicast and/or broadcast service (MBS), a base station can configure one or more UEs with a common frequency resource (CFR) and a physical downlink control channel (PDCCH) configuration configuring a group common PDCCH. The base station can assign a group common radio network temporary identifier (RNTI) to the UEs to receive physical downlink shared channel (PDSCH) transmissions including the MBS data packet(s). Then the base station can send downlink control information (DCI) to the UEs to schedule a PDSCH transmission including MBS data packet(s).

### SUMMARY

A network node provides and manages MBS for one or more UEs in an inactive or idle state. To initiate an MBS session with the one or more UEs, a distributed unit (DU) of a RAN with distributed architecture transmits an identifier for the MBS session through one or more paging messages, causing the UEs the initiate MBS communication. The DU then broadcasts MBS data packets to the UEs in accordance with resource configurations.

Further, the central unit (CU) of the distributed RAN facilitates communication between the DU and the MBS network, providing the identifier for the MBS session and parameters for paging or resource configurations for the MBS session to the DU. The CU in some cases can also provide one or more paging configurations to the DU for use in paging and/or communicating with the UEs.

One example embodiment of these techniques is a method for managing paging of MBS in a distributed architecture, implemented in a CU. The method includes receiving, by processing hardware and from CN, an identifier for an MBS session and an identifier for a UE; transmitting, by the processing hardware to a DU, one or more messages, including the identifier for the MBS session and the identifier for the UE; transmitting, by the processing hardware to the DU, one or more parameters for paging associated with the MBS session; and transmitting, by the processing hardware to the DU, one or more MBS data packets to be broadcast to the UE in accordance with the one or more parameters.

Another example embodiment of these techniques is a method for managing paging of MBS in a distributed architecture, implemented in a DU. The method includes receiving, by processing hardware and from a CU, an identifier for an MBS session and an identifier for a UE; transmitting, by the processing hardware to the UE corresponding to the identifier for the UE, one or more paging messages, including the identifier for the MBS session, when one or more radio connections between the UE and the DU are inactive; and subsequently to the transmitting, broadcasting, by the processing hardware to the UE in accordance with one or more MBS resource configurations, one or more MBS data packets.

### BRIEF DESCRIPTION OF THE DRAWINGS

FIG. 1A is a block diagram of an example system in which a base station and/or a user equipment (UE) can implement the techniques of this disclosure for managing multicast and broadcast services (MBS) in a UE;

FIG. 1B is a block diagram of an example base station including a central unit (CU) and a distributed unit (DU) that can operate in the system of FIG. 1A;

FIG. 2 is a block diagram of an example protocol stack according to which the UE of FIGS. 1A-B can communicate with base stations;

FIG. 3A illustrates an example scenario in which a DU pages an identifier to a UE in an inactive or idle state to begin MBS reception before broadcasting MBS data to the UE;

FIG. 3B illustrates a scenario similar to that of FIG. 3A, but in which the RAN pages an identifier to a UE in an idle state to begin MBS reception before performing a radio connection establishment procedure;

FIG. 3C illustrates a scenario similar to that of FIG. 3B, but in which the RAN pages a UE in an inactive state to begin MBS reception before performing a radio resume procedure;

FIG. 4A illustrates an example scenario in which a CU receives multiple messages from the CN and transmits the messages in turn to the DU, each message including an MBS session identifier and a UE identifier for the particular UE to be paged;

FIG. 4B illustrates a scenario similar to that of FIG. 4A, but in which the CU receives a single message from the CN including the MBS session identifier and an identifier for each UE to join the MBS session;

FIG. 4C illustrates a scenario similar to that of FIG. 4A, but in which the CU transmits a single message to the DU including the MBS session identifier and an identifier for each UE to join the MBS session;

FIG. 5 is a flow diagram of an example method for generating and transmitting one or more messages for the DU, each message including the MBS session identifier, implemented in a CU;

FIG. 6 is a flow diagram of an example method for determining whether to generate and transmit a message for the DU including an MBS session identifier or a UE identifier based on whether the CU determines to page for MBS or unicast service, implemented in a CU;

FIG. 7 is a flow diagram of an example method for determining whether to generate and transmit a message including an MBS session identifier or a message including a UE identifier based on whether the CU is transmitting the message to the DU for an MBS session, implemented in a CU;

FIG. 8 is a flow diagram of an example method for determining whether to generate and transmit a message including a UE identifier and/or a first paging cycle configuration or a message including a second paging cycle configuration based on whether a message received from the CN includes the first paging cycle, implemented in a CU;

FIG. 9 is a flow diagram of an example method for determining whether to include an MBS session identifier in a message based on whether the CU instructs the DU to page the UE for an MBS, implemented in a CU;

FIG. 10A is a flow diagram of an example method for generating and transmitting a DCI and a scrambled CRC in a first time instance and a paging message in a second time instance, implemented in a DU;

FIG. 10B is a flow diagram of an example method similar to FIG. 10A, but in which the DU generates and transmits a plurality of DCIs and scrambled CRCs to the UEs, implemented in a DU;

FIG. 11A is a flow diagram of an example method for determining whether to generate and transmit a paging message including an MBS identifier or a UE identifier based on whether a message from the CU requests paging for MBS or unicast service, implemented in a DU;

FIG. 11B is a flow diagram of an example method similar to FIG. 11A, but in which the DU determines whether to transmit a first paging message in a first paging cycle or a second paging message in a second paging cycle based on the message from the CU, implemented in a DU;

FIG. 12 is a flow diagram of an example method for determining whether to transmit a message according to a first paging cycle or a second paging cycled based on whether the DU receives a message from the CU including the first paging cycle, implemented in a DU;

FIG. 13 is a flow diagram of an example method for determining whether to transmit a message including an identifier for the CN or an identifier for the MBS session based on whether UE paging identity is a CN or MBS session identity, implemented in a CU;

FIG. 14A is a flow diagram of an example method for receiving a message from the CN and generating and transmitting a paging message and a DCI to a UE over multiple paging cycles, the paging cycles determined in accordance with a UE identifier, implemented in a RAN;

FIG. 14B is a flow diagram of an example method similar to FIG. 14A, but in which the paging cycles are determined in accordance with an identifier for the MBS, implemented in a RAN;

FIG. 15 is a flow diagram of an example method for managing paging for multicast and broadcast services, implemented in a DU; and

FIG. 16 is a flow diagram of an example method for managing paging for multicast and broadcast services, implemented in a CU.

### DETAILED DESCRIPTION OF THE DRAWINGS

Generally speaking, the techniques of this disclosure allow UEs to receive MBS information via radio resources allocated by a base station of a RAN. To this end, the base station can configure different radio resources in one or multiple overlapping cells to multicast or broadcast MBS data (and associated control information) and/or unicast non-MBS data (and associated control information) with one or multiple UEs on the downlink (DL). Note that “transmit” by a base station may interchangeably refer to “multicast”, “broadcast”, and/or “unicast.” The base station can also unicast MBS data (and associated control information) to a UE on a dedicated DRB for the UE. The one or more multiple UEs can transmit non-MBS data to the base station on the uplink (UL).

Accordingly, a base station of this disclosure can configure one or more radio bearers to transmit MBS information (i.e., MBS data packets and/or control information) to a UE. A radio bearer that carries MBS information to the UE can be a unicast DRB (i.e., a dedicated DRB for the UE) or a multicast DRB (i.e., a DRB that may be shared by multiple UEs, also referred to as an MBS radio bearer or MRB). For example, the base station can transmit unicast configuration parameters or multicast configuration parameters to the UE to configure the UE to receive MBS information via a unicast DRB or a multicast DRB, respectively. As used in this disclosure, the term DRB may refer to a unicast DRB or a multicast DRB, unless specifically noted otherwise.

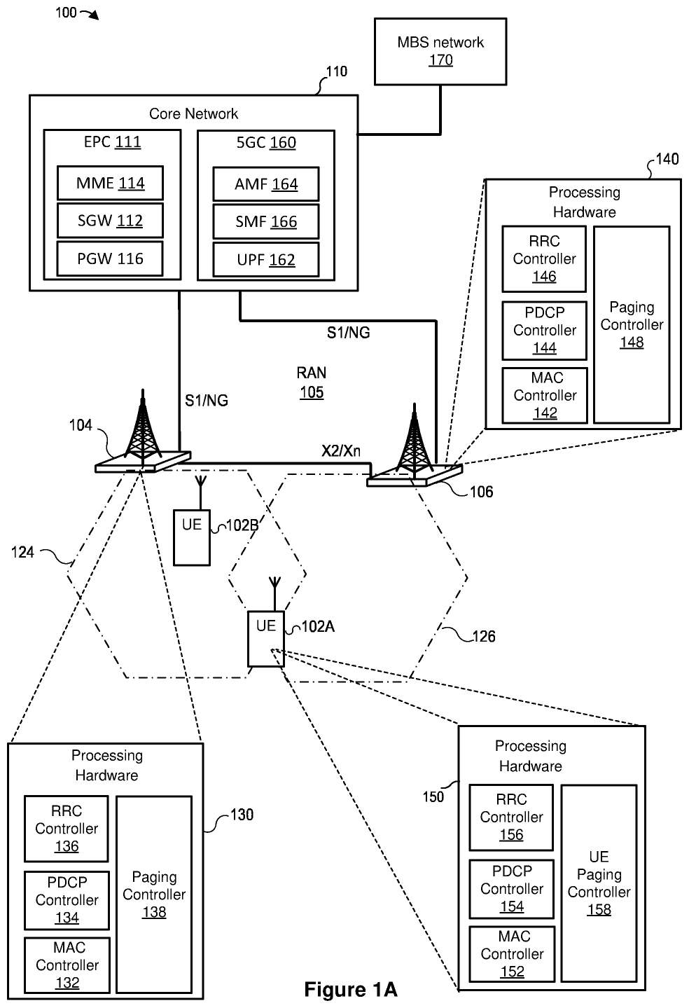

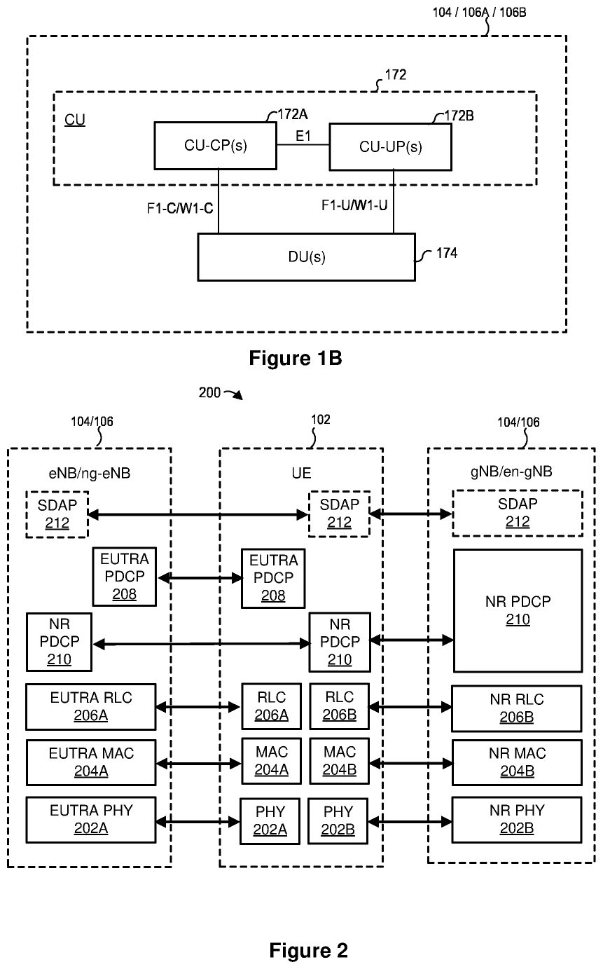

FIG. 1A depicts an example wireless communication system 100 that can implement MBS operation techniques of this disclosure. The wireless communication system 100 includes UE 102A and UE 102B, as well as base stations 104, 106A, 106B of a radio access network (RAN) (e.g., RAN 105) that are connected to a core network (CN) 110. To ease readability, UE 102 is used herein to represent the UE 102A, the UE 102B, or both the UE 102A and UE 102B, unless otherwise specified. The base stations 104, 106A, 106B can be any suitable type, or types, of base stations, such as an evolved node B (eNB), a next-generation eNB (ng-eNB), a 5G Node B (gNB) or a 6G base station, for example. As a more specific example, the base station 104 can be an eNB or a gNB, and the base stations 106A and 106B can be gNBs.

The base station 104 supports a cell 124, the base station 106A supports a cell 126A, and the base station 106B supports a cell 126B. The cell 124 partially overlaps with both of cells 126A and 126B, such that the UE 102 can be in range to communicate with base station 104 while simultaneously being in range to communicate with base station 106A or 106B (or in range to detect or measure the signal from both base stations 106A and 106B). The overlap can make it possible for the UE 102 to hand over between cells (e.g., from cell 124 to cell 126A or 126B) or base stations (e.g., from base station 104 to base station 106A or base station 106B) before the UE 102 experiences radio link failure, for example. Moreover, the overlap allows the UE 102 to operate in dual connectivity (DC) with the RAN 105. For example, the UE 102 can communicate in DC with the base station 104 (operating as a master node (MN)) and the base station 106A (operating as a secondary node (SN)) and, upon completing a handover to base station 106B, can communicate with the base station 106B (operating as an MN). As another example, the UE 102 can communicate in DC with the base station 104 (operating as an MN) and the base station 106A (operating as an SN) and, upon completing an SN change, can communicate with the base station 104 (operating as an MN) and the base station 106B (operating as an SN).

More particularly, when the UE 102 is in DC with the base station 104 and the base station 106A, the base station 104 operates as a master eNB (MeNB), a master ng-eNB (Mng-eNB), or a master gNB (MgNB), and the base station 106A operates as a secondary gNB (SgNB) or a secondary ng-eNB (Sng-eNB).

In non-MBS (i.e., unicast) operation, the UE 102 can use a radio bearer (e.g., a DRB or an SRB) that at different times terminates at an MN (e.g., the base station 104) or an SN (e.g., the base station 106). For example, after handover or SN change to the base station 106B, the UE 102 can use a radio bearer (e.g., a DRB or an SRB) that at different times terminates at the base station 106B. The UE 102 can apply one or more security keys when communicating on the radio bearer, in the uplink (UL) direction (i.e., from the UE 102 to a base station) and/or downlink (DL) direction (i.e., from a base station to the UE 102). In non-MBS operation, the UE 102 transmits data via the radio bearer on (i.e., within) an uplink BWP of a cell to the base station and/or receives data via the radio bearer on a DL BWP of the cell from the base station. The UL BWP can be an initial UL BWP or a dedicated UL BWP, and the DL BWP can be an initial DL BWP or a dedicated DL BWP. The UE 102 can receive paging, system information, public warning message(s), or a random access response on the DL BWP. In such non-MBS operation, the UE 102 can be in a connected state. Alternatively, the UE 102 can be in an idle or inactive state if the UE 102 supports small data transmission in the idle or inactive state.

In MBS operation, the UE 102 can use a radio bearer (e.g., a DRB or an MRB) that at different times terminates at an MN (e.g., the base station 104) or an SN (e.g., the base station 106A). For example, after handover or SN change to the base station 106B, the UE 102 can use a radio bearer (e.g., a DRB or an MRB) that at different times terminates at the base station 106B which can be an MN or SN. The base station can utilize the radio bearer to transmit application-level messages, such as security keys, to the UE 102. In some implementations, the base station (e.g., the MN or SN) can transmit MBS data over dedicated radio resources (i.e., the radio resources dedicated to the UE 102) to the UE 102 (e.g., via the DRB or MRB). In such implementations, the base station can apply one or more security keys to protect integrity of MBS data and/or encrypt MBS data and transmits the encrypted and/or integrity protected MBS data over the dedicated radio resources to the UE 102. Correspondingly, the UE 102 can apply the one or more security keys to decrypt MBS data and/or check integrity of the MBS data when receiving the MBS data on the radio bearer, in the downlink (from a base station to the UE 102) direction. In other implementations, the base station (e.g., the MN or SN) can transmit MBS data over common radio resources (i.e., the radio resources common to the UE 102 and other UE(s) such as common frequency resources (CFR)) or a DL BWP of a cell from the base station to the UE 102 (e.g., via the DRB or MRB). The DL BWP can be an initial DL BWP, a dedicated DL BWP, or an MBS DL BWP (i.e., a DL BWP specific for MBS or not for unicast). In such implementations, the base station can refrain from applying a security key to MBS data and transmit the MBS data on the radio bearer. Correspondingly, the UE 102 can omit applying a security key to MBS data received on the radio bearer. The UE 102 can apply an application-level security key, received from the CN 110 or an MBS server, to MBS data received on the radio bearer.

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation in FIG. 1A includes a base station MBS controller 132 that is configured to manage or control transmission of MBS information received from the CN 110 or an edge server. For example, the base station MBS controller 132 can be configured to support Radio Resource Control (RRC) configurations, procedures and messaging associated with MBS procedures, and/or to support the necessary operations (e.g., MBS activation notification), as discussed below. The processing hardware 130 can include a base station non-MBS controller 134 configured to manage or control one or more RRC configurations and/or RRC procedures when the base station 104 operates as an MN or SN during a non-MBS operation.

The base station 106A includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes a base station MBS controller 142 that is configured to manage or control transmission of MBS information received from the CN 110 or an edge server. For example, the base station MBS controller 142 can be configured to support RRC configurations, procedures and messaging associated with MBS procedures, and/or to support the necessary operations (e.g., MBS activation notification), as discussed below. The processing hardware 140 can include a base station non-MBS controller 144 configured to manage or control one or more RRC configurations and/or RRC procedures when the base station 106A operates as an MN or SN during a non-MBS operation. While not shown in FIG. 1A, the base station 106B can include processing hardware similar to the processing hardware 130 of the base station 104 or the processing hardware 140 of the base station 106A.

The UE 102 includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes a UE MBS controller 152 that is configured to manage or control reception of MBS information. For example, the UE MBS controller 152 can be configured to support RRC configurations, procedures and messaging associated with MBS procedures, and/or to support the necessary operations (e.g., MBS activation notification), as discussed below. The processing hardware 150 can include a UE non-MBS controller 154 configured to manage or control one or more RRC configurations and/or RRC procedures in accordance with any of the implementations discussed below, when the UE 102 communicates with an MN and/or an SN during a non-MBS operation.

The CN 110 can be an evolved packet core (EPC) 111 or a fifth-generation core (5GC) 160, both of which are depicted in FIG. 1A. The base station 104 can be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. The base station 106A can be an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104, 106A, and 106B can support an X2 or Xn interface.

Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions. The UPF 162, AMF 164 and/or the SMF 166 can be configured to support MBS. For example, the SMF 166 can be configured to manage or control MBS transport, configure the UPF 162 and/or RAN 105 for MBS flows, and/or manage or configure MBS session(s) or PDU Session(s) for MBS for UE 102. The UPF 162 is configured to transfer MBS data packets to audio, video, Internet traffic, etc. to the RAN 105. The UPF 162 and/or SMF 166 can be configured for both unicast service and MBS, or for MBS only.

Generally, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, the base station 106B can operate as an MeNB, an Mng-eNB, an MgNB, an SgNB, or an Sng-eNB, and the base station 106A can operate as an SgNB or an Sng-eNB. The UE 102 can communicate with the base station 104 and the base station 106A or 106B via the same radio access technology (RAT), such as EUTRA or NR, or via different RATs.

When the base station 104 is an MeNB and the base station 106A is an SgNB, the UE 102 can be in EN-DC with the MeNB 104 and the SgNB 106A. When the base station 104 is an Mng-eNB and the base station 106A is an SgNB, the UE 102 can be in next generation (NG) EUTRA-NR DC (NGEN-DC) with the Mng-eNB 104 and the SgNB 106A. When the base station 104 is an MgNB and the base station 106A is an SgNB, the UE 102 can be in NR-NR DC (NR-DC) with the MgNB 104 and the SgNB 106A. When the base station 104 is an MgNB and the base station 106A is an Sng-eNB, the UE 102 can be in NR-EUTRA DC (NE-DC) with the MgNB 104 and the Sng-eNB 106A.

With continued reference to FIG. 1A, the CN 110 communicatively connects the UE 102, to an MBS network 170, via the RAN 105. The MBS network 170 can provide to the UE 102 multicast and/or broadcast services (MBS) to UEs that can be useful in many content delivery applications, such as transparent IPv4/IPv6 multicast delivery, IPTV, software delivery over wireless, group communications, IoT applications, V2X applications, and emergency messages related to public safety. To this end, an entity (e.g., a server or a group of servers) operating in the MBS network 170 supports packet exchange with the UE. The packets can convey signaling (such as session initiation protocol (SIP) messages, IP messages, or other suitable messages) as well as data (“or media”) such as text messages, audio and/or video.

FIG. 1B depicts an example, distributed implementation of any one or more of the base stations 104, 106A, and/or 106B. In this implementation, the base station 104, 106A, or 106B includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 106A) operates as an MN or an SN. The processing hardware can also include a physical layer controller configured to manage or control one or more physical layer operations or procedures.

In some implementations, the CU 172 can include a logical node CU-CP 172A that hosts the control plane part of the Packet Data Convergence Protocol (PDCP) protocol of the CU 172 and/or radio resource control (RRC) protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit the non-MBS control information and MBS control information, and the CU-UP 172B can transmit the non-MBS data packets and MBS data packets, as described herein.

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C interface. The CU-UP 172B can be connected to one or more DU 174 through the F1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

FIG. 2 illustrates, in a simplified manner, an example protocol stack 200 according to which the UE 102 can communicate with an eNB/ng-eNB or a gNB (e.g., one or more of the base stations 104, 106A, and/or 106B).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to the EUTRA PDCP sublayer 208 and, in some cases, to the NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides RLC channels to the NR PDCP sublayer 210. The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and an SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets”. The packets can be MBS packets or non-MBS packets. For example, the MBS packets include MBS data packets including application content for an MBS service (e.g., IPv4/IPv6 multicast delivery, IPTV, software delivery over wireless, group communications, IoT applications, V2X applications, and/or emergency messages related to public safety). In another example, the MBS packets include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

In scenarios where the UE 102 operates in EN-DC with the base station 104 operating as an MeNB and the base station 106A operating as an SgNB, the wireless communication system 100 can provide the UE 102 with an MN-terminated bearer that uses EUTRA PDCP sublayer 208, or an MN-terminated bearer that uses NR PDCP sublayer 210. The wireless communication system 100 in various scenarios can also provide the UE 102 with an SN-terminated bearer, which uses only the NR PDCP sublayer 210. The MN-terminated bearer can be an MCG bearer, a split bearer, or an MN-terminated SCG bearer. The SN-terminated bearer can be an SCG bearer, a split bearer, or an SN-terminated MCG bearer. The MN-terminated bearer can be an SRB (e.g., SRB1 or SRB2) or a DRB. The SN-terminated bearer can be an SRB or a DRB.

In some implementations, a base station (e.g., base station 104, 106A or 106B) broadcasts MBS data packets via one or more MBS radio bearers (MRB(s)), and in turn the UE 102 receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE 102 uses PHY sublayer 202, MAC sublayer 204, and RLC sublayer 206 to receive the MBS data packets. In such implementations, the base station and the UE 102 may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE 102 uses PHY sublayer 202, MAC sublayer 204, RLC sublayer 206 and PDCP sublayer 208 to receive the MBS data packets. In such implementations, the base station and the UE 102 may not use a SDAP sublayer 212 to communicate the MBS data packets. In yet other implementations, the base station transmits the MBS data packets via the SDAP sublayer 212, PDCP sublayer 208, RLC sublayer 206, MAC sublayer 204 and PHY sublayer 202, and correspondingly, the UE 102 uses PHY sublayer 202, MAC sublayer 204, RLC sublayer 206, PDCP sublayer 208, and the SDAP sublayer 212 to receive the MBS data packets.

To simplify the following description, the UE 102 represents the UE 102A and the UE 102B, unless explicitly described.

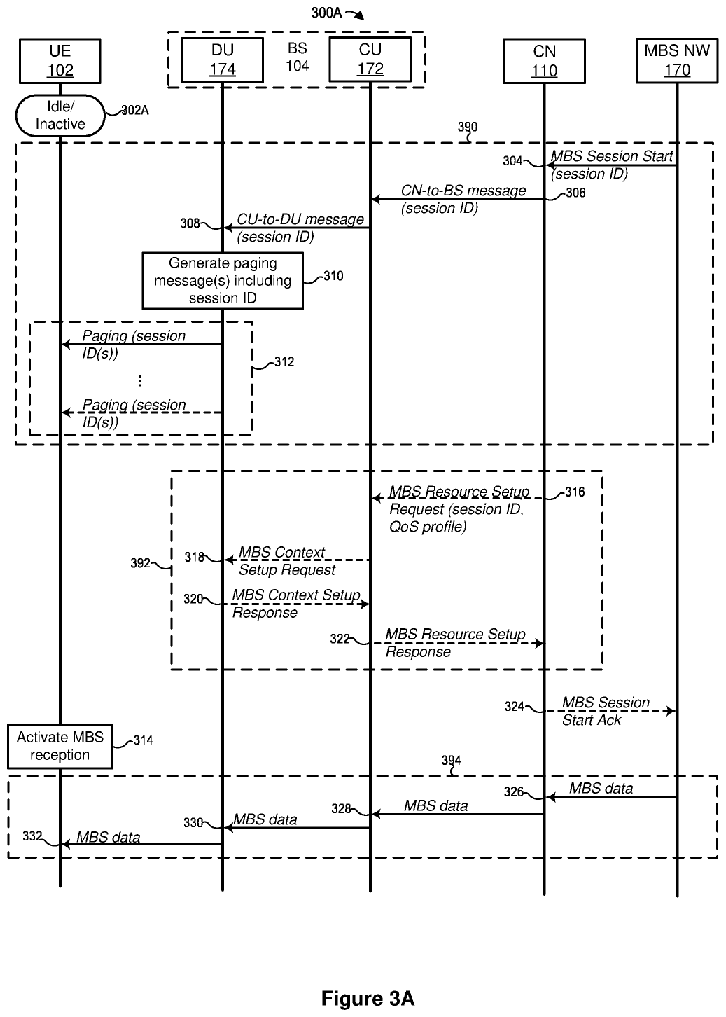

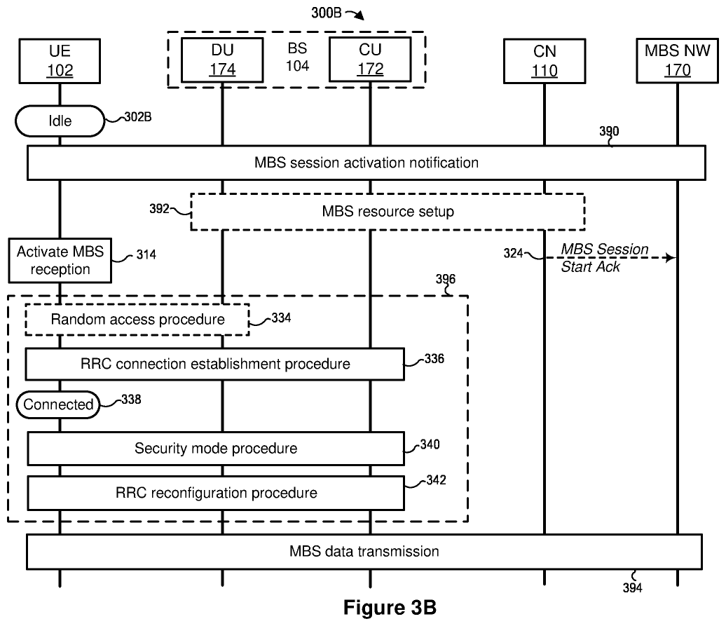

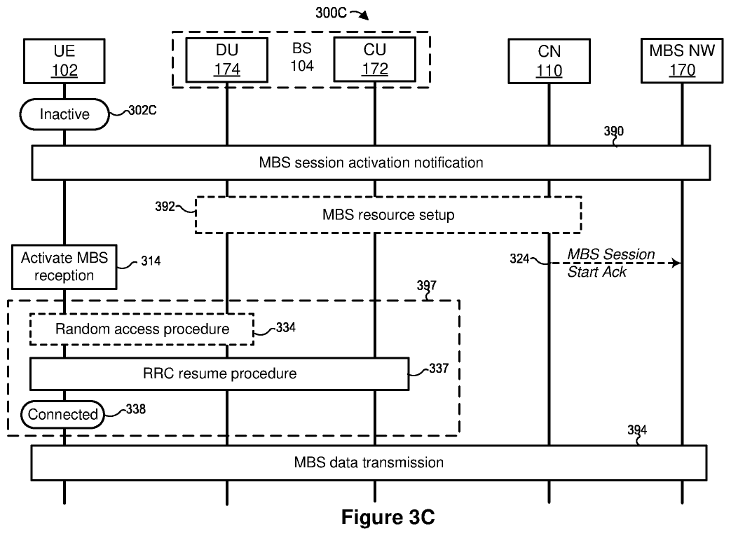

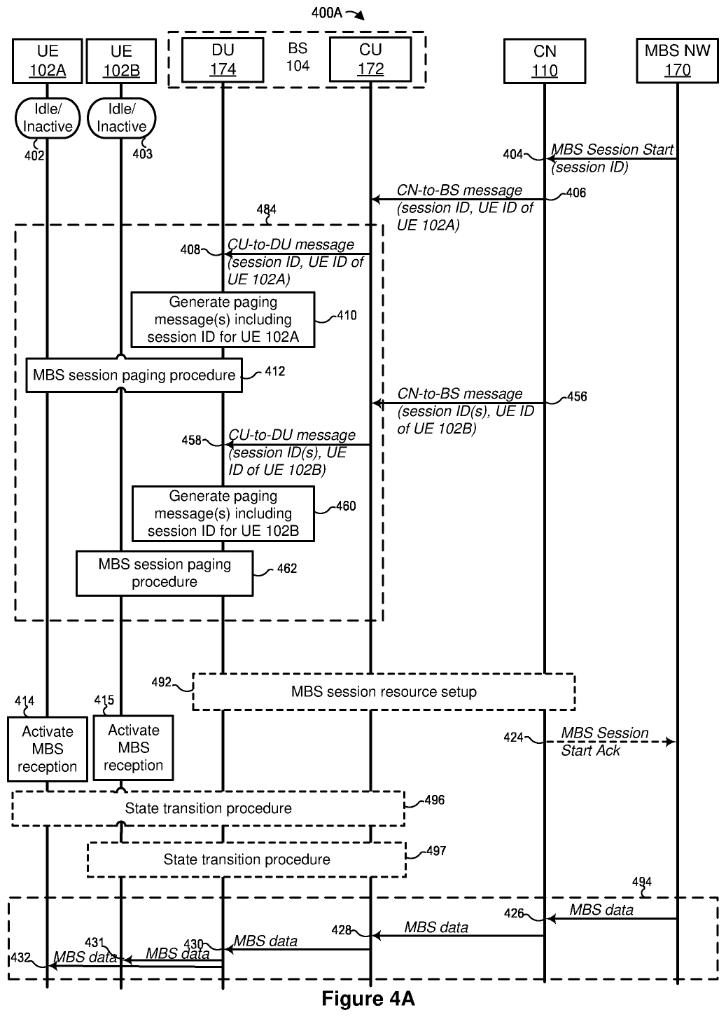

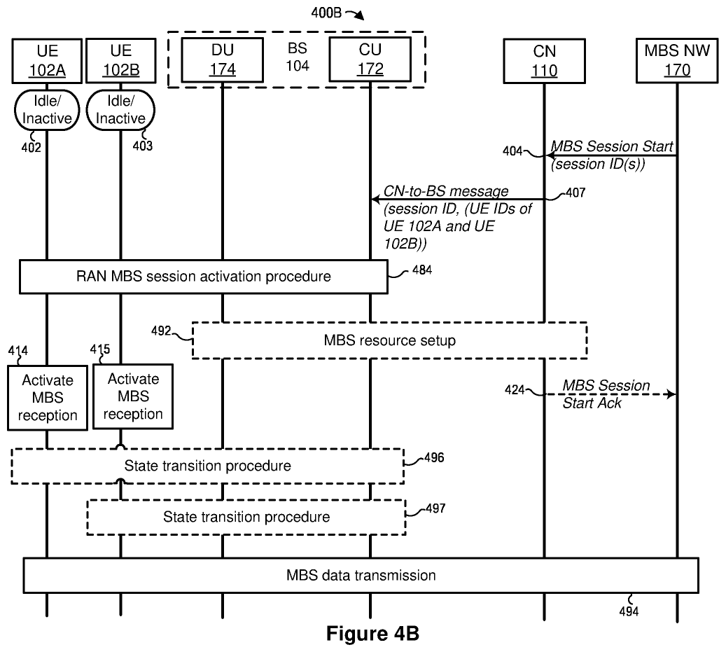

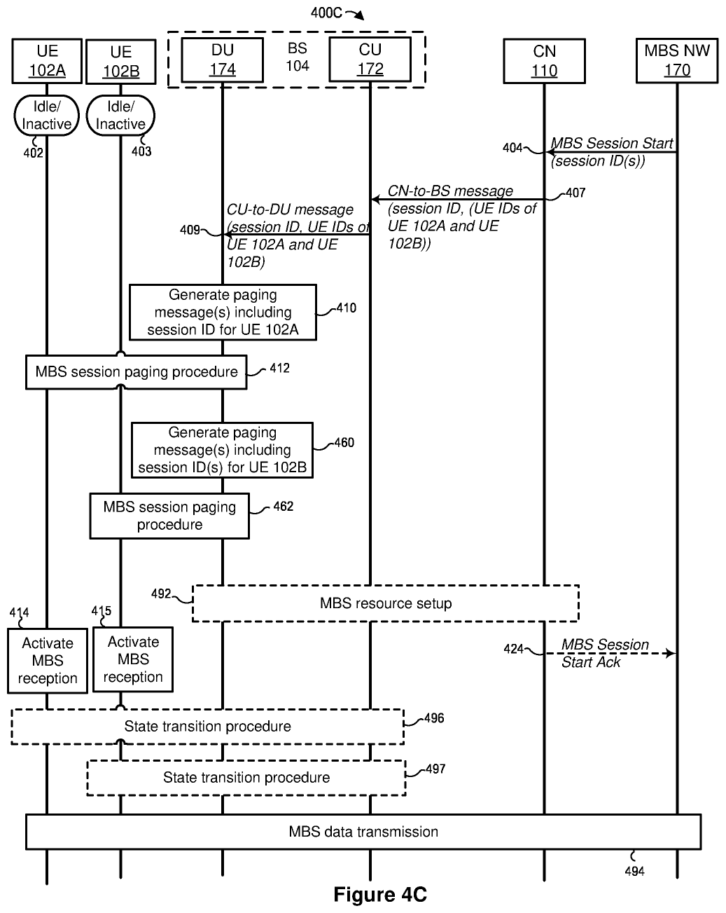

FIGS. 3A-4C are messaging diagrams of example scenarios in which one or more UEs, the RAN, the CN and the MBS network implement the techniques of this disclosure for managing MBS transmission and reception. Generally speaking, events in FIGS. 3A-4C that are similar are labeled with similar reference numbers, with differences discussed below where appropriate. With the exception of the differences shown in the figures and discussed below, any on the alternative implementations discussed with respect to a particular event (e.g., for messaging and processing) may apply to events labeled with similar reference numbers in other figures.

Now referring to a scenario 300A illustrated in FIG. 3A, UE 102 (e.g., the UE 102A and/or UE 102B) initially operates 302A in an idle state (e.g., RRC_IDLE state) or an inactive state (e.g., RRC_INACTIVE state) with RAN 105. The UE 102 operating in the idle state or the inactive state camps on a cell 124 of base station 104 including a DU 174 and a CU 172. MBS network 170 sends 304 an MBS Session Start message (or called MBS Session Start Request message) to CN 110 (e.g., AMF 164) to request activation of an MBS session. The MBS network 170 includes an MBS session ID to identify the MBS session in the MBS Session Start message. In some implementations, the MBS session ID is allocated by the CN 110. In other implementations, the MBS session ID is allocated by the MBS network 170. In some implementations, the MBS session ID can be or include a Temporary Mobile Group Identity (TMGI). In other implementations, the MBS session ID can be associated with a TMGI.

In response to the MBS Session Start message, the CN 110 can notify UEs of activation of the MBS session. To notify UEs of the MBS session activation, the CN 110 generates a CN-to-BS message including the MBS session ID and sends 306 the CN-to-BS message to the RAN 105. In some implementations, the CN-to-BS message can be an existing or new next generation application protocol (NGAP) message defined in 3GPP specification 38.413. For example, the existing NGAP message can be a NGAP Paging message. In other implementations, the CN-to-BS message can be a 6G application protocol (6GAP) Paging message.

Upon receiving 306 the CN-to-BS message, the CU 172 extracts the MBS session ID from the CN-to-BS message, generates a CU-to-DU message including the MBS session ID and transmits 308 the CU-to-DU message to the DU 174. Upon receiving 308 the CU-to-DU message, the DU 174 generates 310 one or more paging messages including the MBS session ID. Then the DU 174 transmits 312 (i.e., via broadcast) the paging message(s) on one or more radio resources, e.g., on the cell 124. Event 312 can define an MBS session paging procedure. The DU 174 can transmit the paging message(s) on a paging control channel (PCCH). In some implementations, the DU 174 can generate a DCI and a CRC of the DCI from the DCI to transmit a particular paging message of the paging message(s). The DCI(s) for transmission of the paging message(s) can be the same or different. The DU 174 scrambles the CRC with a paging radio network temporary identifier (P-RNTI). The DU 174 can include a downlink assignment in the DCI, which indicates a radio resource for a transmission of the paging message. The DU 174 can transmit the DCI and the scrambled CRC on a PDCCH to the UE 102 and then transmit the paging message on the indicated radio resource. When the UE 102 (i.e., the UE 102A and UE 102B) receives the DCI and the scrambled CRC on the PDCCH, the UE 102 verifies the scrambled CRC with the P-RNTI. If the UE 102 verifies that the scrambled CRC is valid, the UE 102 receives or attempts to receive 312 the paging message on the radio resource in accordance with the DCI. After or in response to receiving 312 the paging message, the UE 102 in the idle state or the inactive state activates (e.g., initiates) 314 reception of the MBS session identified by the MBS session ID.

In some implementations, the DU 174 transmits the DCI(s) and scrambled CRC(s) in PDCCH monitoring occasion(s) in paging occasion(s) where the UE 102A and UE 102B can receive. In some scenarios and implementations, other UE(s) receive the DCI(s) and scrambled CRC(s) in the paging occasion(s). In some implementations, the paging occasion(s) are within group paging DRX cycle(s) (or called MBS (paging) DRX cycle(s)). The DU 174 can transmit (e.g., via broadcast) a group paging DRX cycle configuration (called MBS paging DRX cycle configuration) configuring the group paging DRX cycle(s), e.g., on the cell 124. In some implementations, the DU 174 broadcasts system information including the group paging DRX cycle configuration on a BCCH. Alternatively, the DU 174 can broadcast a message including the group paging DRX cycle configuration on a MCCH. Thus, the UE 102A and UE 102B can receive the group paging DRX cycle configuration from the system information or the message on the MCCH. The DU 174 can receive the group paging DRX cycle configuration from the CU 172 or an Operation, Administration and Maintenance (OAM) node. In other implementations, the UE 102A, UE 102B, and CU 172 receive the group paging DRX cycle configuration form the CN 110. For example, the UE 102A and UE102B can perform a NAS procedure with the CN 110 to receive the group paging DRX cycle configuration. For example, the NAS procedure is a registration procedure. In another example, the NAS procedure is an MBS session join procedure, an MBS session activation procedure, or an MBS-related procedure. The CN 110 can send the group paging DRX cycle configuration in the CN-to-BS message that the CN 110 transmits 306. Then, the CU 172 can include the group paging DRX cycle in the CU-to-DU message that CU 172 transmits 308.

In other implementations, the paging occasion(s) are within first paging DRX cycle(s) of the UE 102A and second paging DRX cycle(s) of the UE 102B. In some such cases, the first and second paging DRX cycles are partially or completely overlapped. In cases where the other UE(s) receive the DCI(s) and scrambled CRC(s) on the paging occasion(s), the paging occasion(s) are within third paging DRX cycle(s) of the other UE(s). In such cases, the first, second and third paging DRX cycles are partially or completely overlapped. In some implementations, the UE 102A, UE 102B, and other UE(s) can derive or determine the first paging DRX cycle, second paging DRX cycle, third paging DRX cycle(s) respectively in accordance with section 7.1 in 3GPP specification 38.304. In some implementations, the CU 172 receives the first, second and/or third paging DRX cycle configurations from the CN 110, e.g., in the CN-to-BS message or in another CN-to-BS message. The CU 172 can determine the paging occasion(s) from the paging DRX cycle configurations and indicate the paging occasion(s) in the CU-to-DU message. In other implementations, the DU 174 receives the first, second, and/or third paging DRX cycle configurations from the CU 172, e.g., in the CU-to-DU message or in another CU-to-DU message.

In some implementations, the DU 174 transmits the DCIs and scrambled CRCs in multiple PDCCH occasions (or called PDCCH monitoring occasions) irrespective of a paging DRX cycle. In some implementations, the DU 174 transmits (e.g., via broadcast) system information to configure the multiple PDCCH occasions to the UE 102A, UE 102B, and/or other UE(s). For example, the system information can include a search space configuration (e.g., pagingSearchSpace) and/or PDCCH monitoring configuration(s) (e.g., firstPDCCH-MonitoringOccasionOfPO and nrofPDCCH-MonitoringOccasionPerSSB-InPO). Each of the UE 102A, UE 102B and/or other UE(s) monitor a particular portion of the multiple PDCCH occasions in accordance with the multiple PDCCH occasions. For example, the UE 102A can monitor a first portion of the multiple PDCCH occasions in accordance with the first paging DRX cycle configuration, the UE 102B can monitor a second portion of the multiple PDCCH occasions in accordance with the second paging DRX cycle configuration, and/or the other UE(s) can monitor a third portion of the multiple PDCCH occasions in accordance with the third paging DRX cycle configuration(s). Events 304, 306 and 308 collectively define an MBS session activation notification procedure 390.

After receiving 304 the MBS Session Start message, the CN 110 sends 316 an MBS Resource Setup Request message to the CU 172 (e.g., MBS Session Resource Setup Request message), the message including the MBS session ID, to request the CU 172 to assign resources on an air interface (e.g., Uu) and resources on a network interface (e.g., NG-U) between the CU 172 and the CN 110 for an MBS session identified by the MBS session ID. In some implementations, the CN 110 includes in the MBS Resource Setup Request message a quality of service (QoS) profile to indicate QoS parameters associated with the MBS session. In some implementations, the CN 110 sends the MBS Resource Setup Request message in response to receiving the MBS Session Start message. In one implementation, the CN 110 sends the MBS Resource Setup Request message after transmitting 306 the CN-to-BS message. In another implementation, the CN 110 sends the MBS Resource Setup Request message before transmitting 306 the CN-to-BS message. In response to the MBS Resource Setup Request message, the CU 172 can transmit 322 an MBS Resource Setup Response message (e.g., MBS Session Resource Setup Response message) to the CN 110.

In response to or after receiving the MBS Session Resource Setup message, the CU 172 can send 318 an MBS Context Setup Request message to the DU 174 to request the DU 174 to assign radio resources for transmitting (e.g., broadcasting or multicasting) data of the MBS session. In response, the DU 174 assigns radio resources for transmitting (e.g., broadcasting or multicasting) data of the MBS session and sends 320 an MBS Context Setup Response to the CU 172 to confirm that the DU 174 assigns radio resources for transmitting (e.g., broadcasting or multicasting) data of the MBS session. The radio resources include time resources (e.g., time slots or OFDM symbols) and/or frequency resources (e.g., resource blocks) for one or more control channels and/or one or more data channels. In some implementations, the DU 174 broadcasts MBS resource configuration(s) to indicate or configure the radio resources, e.g., on the cell 124. The DU 174 can transmit one or more PDSCH transmissions including MBS data packet(s) in accordance with the MBS resource configuration(s). For example, the MBS resource configuration(s) include a PDCCH configuration, a search space configuration and/or a control resource set (CORESET) configuration. The RAN 105 can send downlink control information(s) (DCI(s)) each with a cyclic redundancy check (CRC) scrambled by a RNTI (e.g., a group RNTI (G-RNTI) or an MBS RNTI) on PDCCH(s) to schedule a PDSCH transmission including MBS data packet(s) in accordance with the PDCCH configuration, search space configuration, and/or CORESET configuration. In another example, the MBS resource configuration(s) can include a modulation and coding scheme (MCS), repetitions, and/or hybrid automatic repeat request (HARQ) transmission scheme for broadcasting data of the MBS session. The DU 174 can transmit a PDSCH transmission including MBS data packet(s) in accordance with the configured MBS, repetitions, and/or HARQ transmission scheme. In some implementations, the DU 174 broadcasts system information including the MBS resource configuration(s) on a broadcast control channel (BCCH), e.g., on the cell 124. In other implementations, the DU 174 broadcasts MBS resource configuration(s) on a multicast control channel (MCCH), e.g., on the cell 124. In some implementations, the DU 174 periodically broadcasts the MBS resource configuration(s). In further implementations, the DU 174 broadcasts the MBS resource configuration(s) before or after transmitting 312 the paging message(s).

In some implementations, the CU 172 sends the MBS Resource Setup Response message after receiving the MBS Context Setup Response message. In other implementations, the CU 172 sends the MBS Resource Setup Response message before receiving the MBS Context Setup Response message.

The CN 110 can send 324 an MBS Session Start Acknowledge message to the MBS network 170 in response to the MBS Session Start message. In some implementations, the CN 110 sends the MBS Session Start Acknowledge message after receiving the MBS Resource Setup Response message. In other implementations, the CN 110 sends the MBS Session Acknowledge message to the MBS network irrespective of receiving the MBS Resource Setup Response message. Events 316, 318, 320, 322 collectively define an MBS resource setup procedure 392.

After transmitting the MBS Session Start message or receiving the MBS Session Start Acknowledge message, the MBS network 170 transmits 326 MBS data (e.g., one or more MBS data packets) of the MBS session to the CN 110, which in turn transmits 328 the MBS data to the CU 172. The CU 172 then sends 330 the MBS data to the DU 174, which in turn broadcasts 330 the MBS data using the MBS resource configuration(s), e.g., on the cell 124, as described above.

After or in response to receiving 312 the paging message, the UE 102 in the idle state or the inactive state activates (e.g., initiates) 314 reception of the MBS session identified by the MBS session ID. The UE 102 receives 332 the MBS data in accordance with the MBS resource configuration(s). For example, the UE 102 receives 332 one or more PDSCH transmissions including the MBS data on the radio resources configured by the MBS configuration(s) and decodes the PDSCH transmission(s) in accordance with the MCS to obtain the MBS data. In another example, the UE 102 receives 332 the DCI(s) scheduling PDSCH transmission(s) including the MBS data in accordance with the MBS resource configuration(s) and decodes the PDSCH transmission(s) in accordance with the DCI(s) to obtain the MBS data. Events 318, 320 and 322 collectively define an MBS data transmission procedure 394.

FIG. 3B and FIG. 3C are example message sequences similar to the message sequences of FIG. 3A, but where the UE 102 transitions to a connected state from the inactive state and the idle state, respectively.

Turning first to FIG. 3B, in a scenario 300B, the UE 102 initially operates 302B in the idle state. The UE 102 in the idle state receives an MBS activation notification message (i.e., the MCCH message or the paging message) in the MBS session activation notification procedure 390. In some implementations, the MBS session ID in FIG. 3B identifies a multicast session, and the MBS session ID in FIG. 3A identifies a broadcast session.

In response to the activation 314, the UE 102 performs 336 a RRC connection establishment procedure with the CU 172 via the DU 174. The UE 102 transitions 338 to a connected state (e.g., RRC_CONNECTED state) in response to the RRC connection establishment procedure. To perform 336 the RRC connection establishment procedure, the UE 102 can perform 334 a random access procedure with the DU 174 to synchronize with the DU 174 in uplink transmission, such as in cases where the UE 102 is not uplink synchronized with the DU 174 (i.e., the UE 102 does not have a valid timing advance command or value with the DU 174). The random access procedure can be a two-step or four-step random access procedure. To perform 336 the RRC connection establishment procedure, the UE 102 transmits an RRC request message (e.g., RRCSetupRequest message or RRCConnectionRequest message) to the CU 172 via the DU 174. In some implementations where the UE 102 performs 334 the two-step random access procedure, the UE 102 transmits the RRC request message in a message A of the two-step random access procedure. In further implementations where the UE 102 performs 334 the four-step random access procedure, the UE 102 transmits the RRC request message in a message 3 of the four-step random access procedure. In some implementations where the UE 102 is uplink synchronized with the DU 174 and has a configured grant configuration for the idle state, the UE 102 skips or omits the random access procedure. In some such cases, the UE 102 transmits the RRC Request message to the DU 174 using a configured grant configured by the configured grant configuration. In response to the RRC request message, the CU 172 can transmit a RRC response message (e.g., RRCSetup message or RRCConnectionSetup message) to the UE 102 via the DU 174. In response, the UE 102 transitions 338 to the connected state and transmits a RRC complete message (e.g., RRCSetupComplete message or RRCConnectionSetupComplete message) to the CU 172 via the DU 174. In some implementations, the UE 102 configures a first SRB (e.g., SRB1) to communicate RRC messages with the CU 172 (via the DU 174) in response to the RRC response message. In such implementations, the UE 102 transmits the RRC complete message via the first SRB and the DU 174 to the CU 172. In some implementations, the UE 102 sends a Service Request message to the CN 110 via the DU 174 and CU 172 after transitioning 338 to the connected state. In further implementations, the UE 102 includes the Service Request message in the RRC complete message. The CU 172 retrieves the Service Request message from the RRC complete message sends a first BS-to-CN message (e.g., Initial UE Message message) including the Service Request message to the CN 110.

After performing 336 the RRC connection establishment procedure with the UE 102 or transitioning 338 the UE 102 to the connected state, the CU 172 can perform 340 a security activation procedure (e.g., RRC security mode procedure) with the UE 102 via the DU 174 to activate security (e.g., integrity protection/integrity check and/or encryption/decryption) on communication with the UE 102. In some implementations, the RAN 105 sends a security activation command message (e.g., SecurityModeCommand message) to the UE 102, e.g., via the SRB and the DU 174, to perform 430 the security activation procedure. In response, the UE 102 activates security (e.g., integrity protection and/or encryption) on communication with the CU 172 and transmits a security activation complete message (e.g., SecurityModeComplete) to the CU 172, e.g., via the SRB and the DU 174. After activating the security, the CU 172 can perform a RRC reconfiguration (not shown in FIG. 4A) with the UE 102 via the DU 174 to configure a second SRB (e.g., SRB2) and/or a DRB to exchange RRC messages and/or NAS message with the UE 102.

After transitioning 338 to the connected state or performing 340 the security activation procedure, the UE 102 can perform an MBS session join procedure (also referred to as an MBS session activation procedure or MBS session establishment procedure) with the CN 110 via the RAN 105 to indicate that the UE 102 requests to join the MBS session. In some implementations, the UE 102 determines to do so if the UE 102 does not have an MBS context for receiving the MBS session. In some cases where the UE 102 has an MBS context for receiving the MBS session before receiving the message including the MBS session ID in the MBS session activation notification procedure 390, the UE 102 skips, omits, or refrains from performing the MBS session join procedure. To perform the MBS session join procedure, the UE 102 can send an MBS session join request message (or called MBS session activation request message or MBS session establishment request message) to the CN 110 via the DU 174 and CU 172. In response, the CN 110 can send an MBS session join accept message (or called MBS session activation accept message or MBS session establishment accept message) to the UE 102 via the CU 172 and DU 174. In some implementations, the UE 102 performs the MBS session join procedure after activating 340 the security. Thus, the MBS session join procedure is protected by the security. Upon receiving the MBS session join request message from the UE 102, the CU 172 sends a second BS-to-CN message (e.g., Uplink NAS Transport message), including the MBS session join request message, to the CN 110. In other implementations, the UE 102 performs the MBS session join procedure after transitioning 337 to the connected state and before activating the security. In further implementations, the UE 102 includes the MBS session join request message in the RRC complete message. The CU 172 retrieves the MBS session join request from the RRC complete message and sends the first BS-to-CN message including the MBS session join request message to the CN 110. In some such implementations, the UE 102 determines not to send the Service Request message.

Alternatively, the UE 102 can perform the MBS session join procedure with the MBS network 170 via the CN 110, CU 172 and DU 174, instead of the CN 110. In some such cases, the CN 110 sends the MBS session join request message to the MBS network 170 and receives the MBS session join accept message from the MBS network 170, respectively.

In some implementations, the MBS context includes the MBS session ID. In further implementations, the MBS context includes a QoS profile of the MBS session, an IP address for the MBS session, and/or one or more MRB configurations configuring one or more MRBs.

In some implementations, the CN 110 initiates the MBS resource setup procedure 392 in response to or after receiving the first BS-to-CN message or the second BS-to-CN message. In response to or after receiving the MBS Resource Setup Request message, the CU 172 can perform 342 a RRC reconfiguration procedure with the UE 102 to configure radio resources for the UE 102 to receive 394 MBS data of the MBS session. To perform 342 the RRC reconfiguration procedure, the CU 172 sends a RRC reconfiguration message to the UE 102 via the DU 174. The CU 172 can include, in the RRC reconfiguration message, configuration parameters for the UE 102 to receive 394 MBS data of the MBS session. In some implementations, the CU 172 sets the configuration parameters in accordance with the QoS profile. The UE 102 receives the MBS data in the MBS data transmission procedure 394 in accordance with the configuration parameters. In some implementations, the configuration parameters include physical layer configuration parameter(s), MAC configuration parameter(s), RLC configuration parameter(s), PDCP configuration parameter(s), SDAP configuration parameter(s) and/or MRB configuration parameter(s). The MRB configuration parameter(s) can configure one or more MRBs associated to the MBS session. The CU 172 can obtain some of the configuration parameters (e.g., the physical layer configuration parameters(s), MAC configuration parameter(s), and/or RLC configuration parameter(s)) from the DU 174 in a DU-to-CU message received from the DU 174. For example, in some implementations, the DU-to-CU message is the MBS Context Setup Response or in a UE Context Setup Response message.

In response to the RRC reconfiguration message, the UE 102 can send an RRC reconfiguration complete message to the CU 172 via the DU 174. In some implementations, the CU 172 sends the MBS Resource Setup Response message to the CN 110 before or after receiving the RRC reconfiguration complete message. In other implementations, the CN 110 performs 392 the MBS resource setup procedure with the RAN 105 before receiving the first BS-to-CN message or the second BS-to-CN message. In yet other implementations, the CN 110 performs 392 the MBS resource setup procedure with the CU 172 irrespective of receiving the first BS-to-CN message or performing the MBS session join procedure.

After receiving 324 the MBS Session Start Acknowledge message, the MBS network 170 can perform 394 an MBS data transmission procedure to send MBS data to the UE 102. When the CU 172 receive MBS data from the CN 110 during the MBS data transmission procedure 394, the CU 172 can transmit the MBS data to the UE 102 via multicast and the DU 174. After performing the RRC reconfiguration procedure, the UE 102 uses the configuration parameters to receive the MBS data from the DU 174. In some implementations, the CU 172 transmits the MBS data to the UE 102 via the one or more MRBs and the UE 102 receives the MBS data via the one or more MRBs. Events 334, 336, 338, 340 and 342 collectively define a state transition procedure 396.

Turning to FIG. 3C, a scenario 300C is similar to the scenario 300B, except that the UE 102 initially operates 302C in an inactive state (e.g., RRC_INACTIVE), and, in response to receiving the MBS activation notification message, the UE 102 performs an RRC resume procedure with the CU 172 via the DU 174 rather than the RRC connection establishment procedure. In some scenarios and implementations, the UE 102 was in a connected state with the RAN 105 before the UE 102 begins operating 403 in the inactive state. The UE 102 in the connected state communicates data with the RAN 105, e.g., via one or more radio bearers (RBs). In some implementations, the UE 102 in the connected state communicates the control-plane (CP) data via one or more signaling RBs (SRBs). In some implementations, the UE 102 in the connected state communicates the user-plane (UP) data via one or more data RBs (DRBs). After a certain period of data inactivity for the UE 102, the RAN 105 can determine that neither the RAN 105 nor the UE 102 has transmitted any data in the downlink direction or the uplink direction, respectively, during the certain period. In response to the determination, the RAN 105 can transmit a RRC release message (e.g., RRCRelease message or RRCConnectionRelease message) to the UE 102 and instruct the UE 102 to transition to the inactive state. The UE 102 transitions to the inactive state upon receiving the RRC release message. The RAN 105 can assign an I-RNTI or a resume ID to the UE 102 and include the assigned value in the RRC release message. In some embodiments, after the UE 102 transitions to the inactive state, the UE 102 may perform one or more RAN notification area (RNA) updates with the RAN 105 without state transitions.

In response to the activation 314, the UE 102 can perform 337 an RRC resume procedure with the RAN 105. The UE 102 transitions 428 to a connected state (e.g., RRC_CONNECTED state) in response to the RRC resume procedure. In some implementations, to perform 337 the RRC resume procedure, the UE 102 performs 334 a random access procedure with the DU 174 to synchronize with the DU 174 in uplink transmission, such as in cases where the UE 102 is not uplink synchronized with the DU 174 (i.e., the UE 102 does not have a valid timing advance command or value with the RAN 105). The random access procedure can be a two-step or four-step random access procedure. To perform 337 the RRC resume procedure, the UE 102 transmits a RRC request message (e.g., RRCResumeRequest message or RRCConnectionResumeRequest message) to the CU 172 via the DU 174. In some cases where the UE 102 performs 334 the two-step random access procedure, the UE 102 transmits the RRC request message in a message A of the two-step random access procedure. In further cases where the UE 102 performs 334 the four-step random access procedure, the UE 102 transmits the RRC request message in a message 3 of the four-step random access procedure. In further cases where the UE 102 is uplink synchronized with the DU 174 and has a configured grant configuration for the idle state, the UE 102 skips or omits the random access procedure. In some such cases, the UE 102 transmits the RRC request message using a configured grant that is configured by the configured grant configuration. In response to the RRC request message, the CU 172 can transmit a RRC response message (e.g., RRCResume message or RRCConnectionResume message) to the UE 102 via the DU 174. In response, the UE 102 transitions 338 to the connected state and transmits a RRC complete message (e.g., RRCResumeComplete message or RRCConnectionResumeComplete message) to the RAN 105. In some implementations, the UE 102 operating 302C in the inactive state suspends a first SRB (e.g., SRB1), a second SRB, and/or one or more DRBs. In such implementations, the UE 102 resumes the first SRB to receive the RRC response message in response to or after transmitting the RRC request message and transmits the RRC complete message via the first SRB to the CU 172 via the DU 174. The UE 102 resumes the second SRB in response to the RRC response message. In some implementations, the UE 102 resumes the one or more DRBs in response to the RRC response message, such as in cases where the CU 172 does not indicate release of the one or more DRBs in the RRC response message. In some implementations, the UE 102 does not send a Service Request message to the CN 110 via the DU 174 and CU 172 after transitioning 338 to the connected state, unlike FIG. 3B.

In some implementations, the UE 102 operating 302C in the inactive state has an MBS context for the MBS session as described for FIG. 3B. The UE 102 in the inactive state suspends one or more MRBs in the MBS context. In some such implementations, the UE 102 resumes one or more MRBs in response to the RRC response message, such as in cases where the CU 172 does not indicate release of the one or more MRBs in the RRC response message.

In some implementations, the UE 102 in the MBS data transmission procedure 394 receives MBS data for the MBS session (i.e., a first MBS session) via (one, some, or all of) the one or more MRBs that the UE 102 resumed in response to the RRC resume procedure. In such implementations, the UE 102 refrains from performing an MBS session join procedure to active reception of the MBS session. In other implementations, the UE 102 performs the MBS session join procedure, such as in cases where the UE 102 does not have an MBS context for the MBS session. In some scenarios and implementations, the UE 102 has an MBS context for a second MBS session and resumes one or more MRBs for the second MBS session in response to the RRC resume procedure or the RRC response message. In such cases, the UE 102 does not receive MBS data of the first MBS session via the one or more MRBs of the MBS context for the second MBS session. Thus, the UE 102 performs the MBS session join procedure to cause the RAN 105 to perform a RRC reconfiguration procedure to configure radio resources for the UE 102 to receive MBS data of the first MBS session, similar to event 342. The UE 102 receives the MBS data in the MBS data transmission procedure 394 in accordance with the configuration parameters. In some implementations, the configuration parameters include physical layer configuration parameters, MAC configuration parameters, RLC configuration parameters, PDCP configuration parameters, SDAP configuration parameters, and/or MRB configuration parameters. Events 334, 337, and 338 collectively define a state transition procedure 397.

FIG. 4A-4C are example message sequences similar to the message sequences of FIGS. 3A-3C but where the DU 174 pages the UE 102A and UE 102B in separate paging messages.

In FIG. 4A, the CN 110 sends 406 a first CN-to-BS message and 456 a second CN-to-BS message to the CU 172 to page the UE 102A and UE 102B, respectively, in response to or after receiving 404 an MBS Session Start message including an MBS session ID. More specifically, the CN 110 includes the MBS session ID and a UE ID of the UE 102A (e.g., 5G-S-TMSI) in the first CN-to-BS message to page the UE 102A for the MBS session ID, and the CN 110 includes the MBS session ID and a UE ID of the UE 102B (e.g., 5G-S-TMSI) in the second CN-to-BS message to page the UE 102B for the MBS session ID.

In response to or after receiving the first CN-to-BS message, the CU 172 can send 408 a first CU-to-DU message including the MBS session ID, the UE ID of the UE 102A to the DU 174. In response to or after receiving the second CN-to-BS message, the CU 172 can send 458 a second CU-to-DU message including the MBS session ID, the UE ID of the UE 102B to the DU 174.

In response to or after receiving the first CU-to-DU message, the DU 174 generates 410 one or more paging message, including the MBS session ID, for the UE 102A and transmits 412 the paging message(s) in first paging occasion(s), similar to event 312. In response to or after receiving the second CU-to-BS message, the DU 174 generates 460 one or more paging message, including the MBS session ID, for the UE 102B and transmits 462 the paging message(s) in second paging occasion(s), similar to event 312. In some implementations, the DU 174 determines or derives the first paging occasion(s) based on the UE ID of the UE 102A, a first paging DRX cycle configuration, a search space configuration (e.g., pagingSearchSpace), and/or PDCCH monitoring configuration(s) (e.g., firstPDCCH-MonitoringOccasionOfPO and nrofPDCCH-MonitoringOccasionPerSSB-InPO). Similarly, the DU 174 can determine or derive the second paging occasion(s) based on the UE ID of the UE 102B, a second paging DRX cycle configuration, the search space configuration and/or the PDCCH monitoring configuration(s). In some implementations, the CU 172 includes the first and second paging DRX cycle configurations in the first and second CU-to-DU messages, respectively.

In some implementations, the first and second paging DRX cycle configurations are identical (i.e., the same content). In other implementations, the first and second paging DRX cycle configurations are different. In some implementations, the CN 110 includes the first paging DRX cycle configuration and the second paging DRX cycle configuration in the first and second CN-to-BS messages, respectively. In other implementations, the CU 172 or DU 174 determines the first and second paging DRX cycle configurations and transmits the first and second paging DRX cycle configurations to the UE 102A and UE 102B, respectively. In some cases where the first and second paging DRX cycle configurations are the same paging DRX cycle configurations, the DU 174 broadcasts the paging DRX cycle configuration in system information.

In response to or after receiving 412 the paging message, the UE 102A in some implementations receives 432 MBS data without transitioning to the connected state, as described for FIG. 3A. Similarly, in response to or after receiving 452 the paging message, the UE 102B in some implementations receives 432 MBS data without transitioning to the connected state, as described for FIG. 3A. In other implementations, in response to or after receiving 412 the paging message, the UE 102A performs 496 a state transition procedure, similar to event 396 or 397. After transitioning to the connected state, the UE 102A in the connected state receives 432 the MBS data. Similarly, in response to or after receiving 462 the paging message, the UE 102B in some implementations performs 497 a state transition procedure, similar to event 396 or 397. After transitioning to the connected state, the UE 102B in the connected state receives 432 the MBS data. Events 408, 410, 412, 458, 460 and 462 collectively define a RAN MBS session activation procedure 484.

Turning to FIG. 4B, a scenario 400B is similar to the scenario 400A, except that the CN 110 sends 407 a single CN-to-BS message to the CU 172 to cause the CU 172 to perform 484 the RAN MBS session activation procedure. In some implementations, the CU 172 performs 484 the procedure with the DU 174 to page the UE 102A and 102B, instead of sending 406, 456 the first and second CN-to-BS messages. The CN 110 can include the MBS session ID, the UE ID of the UE 102A and the UE ID of the UE 102B in the CN-to-BS message. In some implementations, the CN 110 includes the first and second paging DRX cycle configurations in the CN-to-BS message. In some cases where the first and second paging DRX cycle configurations are the same, the CN 110 includes a single paging DRX cycle configuration (i.e., the first paging DRX cycle configuration) in the CN-to-BS message.

Turning to FIG. 4C, a scenario 400C is similar to the scenario 400B, except that the CU 172 sends 409 a single CU-to-DU message to the DU 174 to cause the DU 174 to page the UE 102A and 102B, instead of sending 408, 458 the first and second CU-to-DU messages. The CU 172 can include the MBS session ID, the UE ID of the UE 102A and the UE ID of the UE 102B in the CU-to-DU message. In some implementations, the CU 172 includes the first and second paging DRX cycle configurations in the CU-to-DU message. In some cases where the first and second paging DRX cycle configurations are the same, the CU 172 includes a single paging DRX cycle configuration (i.e., the first paging DRX cycle configuration) in the CU-to-DU message.

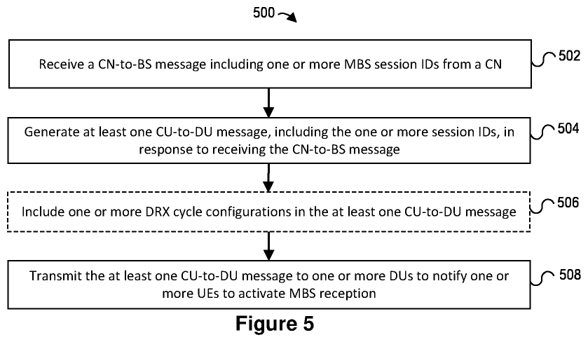

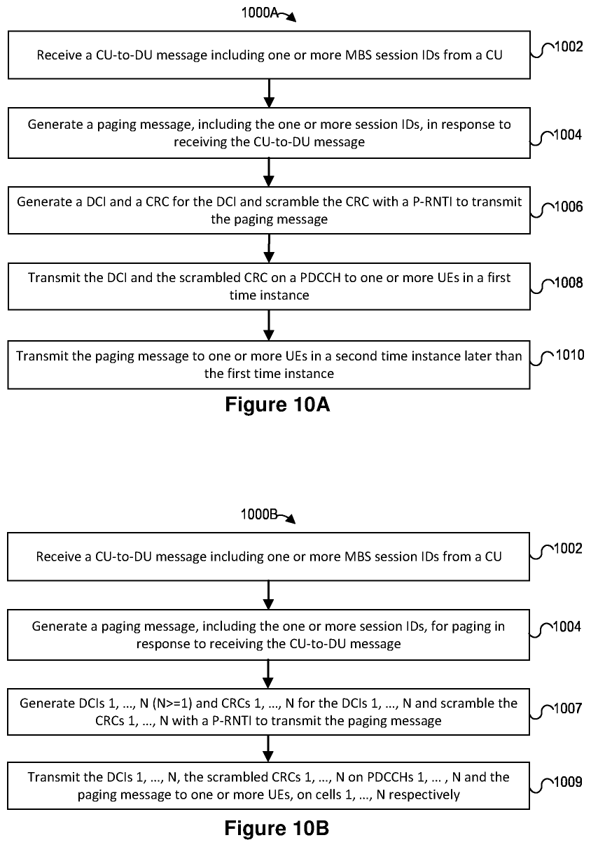

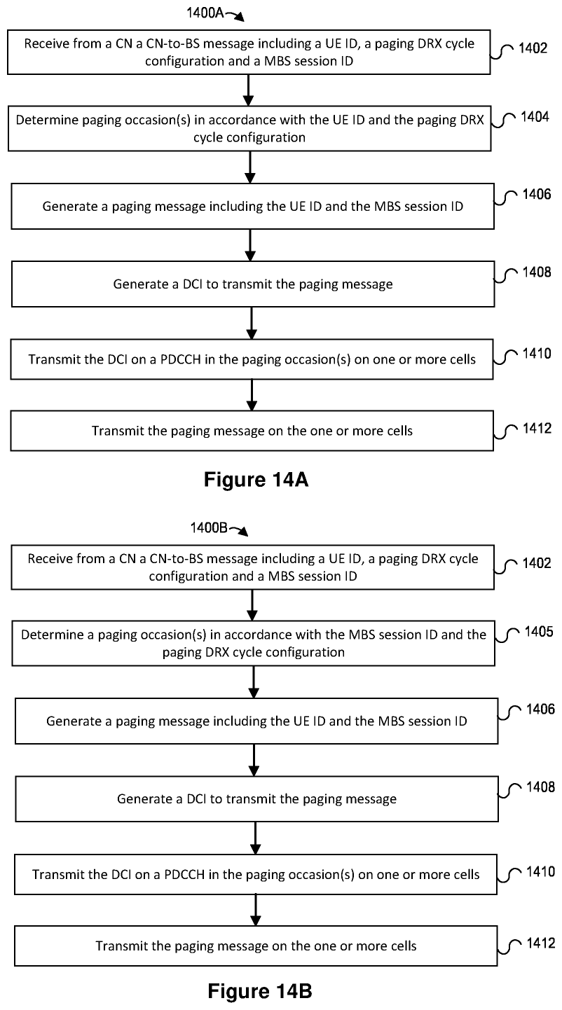

FIGS. 5-9, 13A, 13B, and 16 are flow diagrams depicting example methods that a CU (e.g., the CU 172) can implement to page UEs for an MBS. FIGS. 10A-12 and 15 are flow diagrams depicting example methods that a DU (e.g., the DU 174) can implement to page UEs for an MBS. FIGS. 14A and 14B are flow diagrams depicting example methods that a base station can implement to page UEs for an MBS.

FIG. 5 is a flow diagram of an example method 500 for paging UEs for an MBS. At block 502, the CU 172 receives a message, such as a CN-to-BS message, including one or more MBS session IDs from a CN 110 (e.g., events 306, 390, 406, 407). At block 504, the CU 172 generates at least one message, such as a CU-to-DU message, including the one or more session IDs, in response to receiving the message at block 502 (e.g., events 308, 390, 408, 458, 484, 409). In some implementations, at block 506, the CU 172 includes one or more paging DRX cycle configurations in the at least one message (e.g., events 308, 390, 408, 458, 484, 409). At block 508, the CU 172 transmits the at least one message to one or more DUs 174 to notify one or more UEs 102 to activate MBS reception (e.g., events 308, 390, 408, 458, 484, 409).

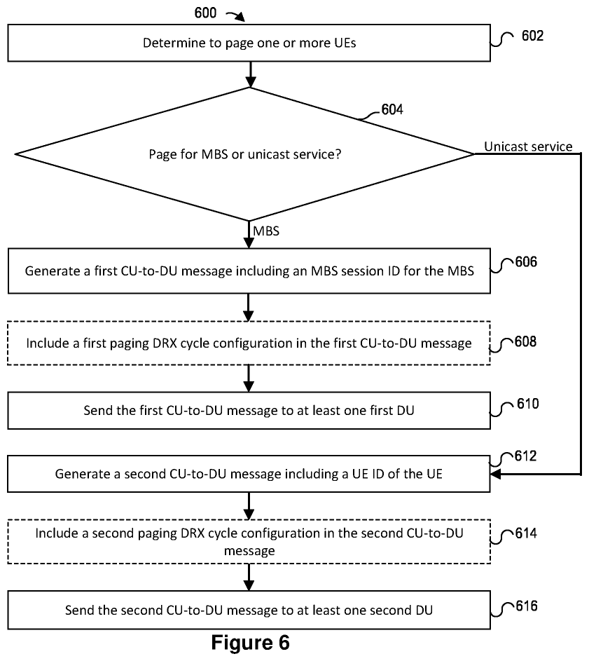

FIG. 6 is a flow diagram of an example method 600 for paging UEs for an MBS. At block 602, the CU 172 determines to page one or more UEs 102. At block 604, the CU 172 determines whether to page for MBS or unicast service. If the CU 172 pages for an MBS, the flow proceeds to blocks 606, 608, and 610. At block 606, the CU 172 generates a first message, such as a CU-to-DU message, including an MBS session ID for the MBS (e.g., events 308, 390, 408, 458, 484, 409). In some implementations, at block 608, the CU 172 includes a first paging DRX cycle configuration in the first message (e.g., events 308, 390, 408, 458, 484, 409). At block 610, the CU 172 sends the first message to at least one first DU 174 (e.g., events 308, 390, 408, 458, 484, 409). If the CU 172 pages for a unicast service (e.g., a messaging application, an email application, a streaming application, etc.), the flow proceeds to blocks 612, 614, and 616. At block 612, the CU 172 generates a second message, such as a CU-to-DU message, including a UE ID of the UE 102. In some implementations, at block 614, the CU 172 includes a second paging DRX cycle configuration in the second message. At block 616, the CU 172 sends the second message to at least one second DU 174.

In some implementations, the first and second messages are F1AP Paging messages. In other implementations, the first and second messages are a new F1AP message (e.g., specific for MBS) and an F1AP Paging message, respectively.

In some implementations, the CU 172 refrains from including a UE radio capability for paging in the first message. In other implementations, the CU 172 includes a common UE radio capability for paging in the first message. The common UE radio capability for paging includes one or more capabilities common for plural UEs. In some implementations, the CU 172 additionally or alternatively includes a UE radio capability for paging of the UE 102 to be paged in the second message.

In some implementations, the at least one first DU and the at least one second DU can include the same DU(s) and/or different DU(s). In some implementations, the first paging DRX cycle configuration is an MBS (paging) DRX configuration or a grouping paging DRX cycle configuration. In further implementations, the second paging DRX cycle configuration is a UE specific DRX cycle configuration or a DRX cycle configuration for unicast paging.

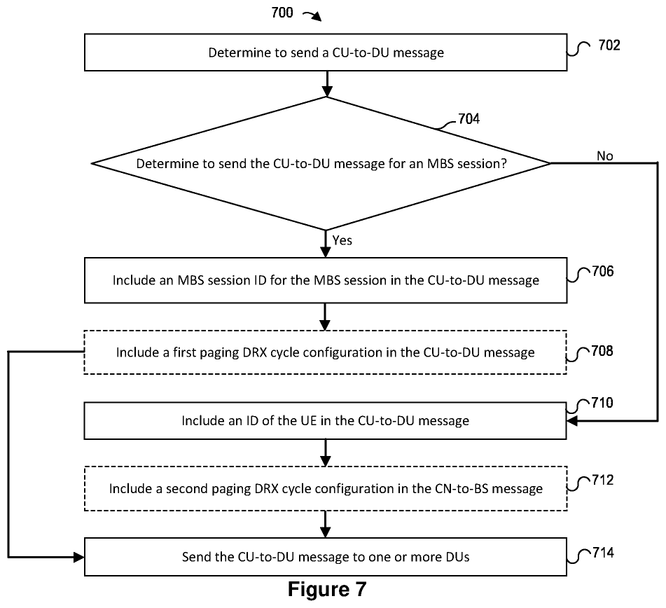

FIG. 7 is a flow diagram of an example method 700 for paging UE(s) an MBS. At block 702, the CN 110 decides to send a message, such as a CU-to-DU message. At block 704, the CU 172 determines whether to send the message for an MBS session. If the CU 172 sends the message for an MBS session, the flow proceeds to blocks 706, 708, and 714. If the CU 172 sends the message for a service other than an MBS session (e.g., the CU 172 sends the message for a unicast service such as a voice call or an Internet service (e.g., a messaging application, an email application, a streaming application, etc.)), the flow proceeds to blocks 710, 712, and 714. At block 706, the CN 110 includes an MBS session ID for the MBS session in the message (e.g., events 308, 390, 408, 458, 484, 409). In some implementations, at block 708, the CU 172 includes a first paging DRX cycle configuration in a CN-to-BS message (e.g., events 308, 390, 408, 458, 484, 409). At block 710, the CU 172 includes an ID for the UE 102 (e.g., 5G-S-TMSI) in the CU-to-DU message. In some implementations, at block 712, the CU 172 includes a second DRX configuration (e.g., non-MBS DRX configuration) in the CN-to-BS message. At block 714, the CU 172 sends the CU-to-DU message to one or more DUs 174 (e.g., events 308, 390, 408, 458, 484, 409).

In some implementations, the CU-to-DU message is a F1AP Paging message. In further implementations, the CU 172 refrains from including a UE radio capability for paging in the message in cases where the CU 172 determines to send the message for an MBS session. In other implementations, the CU 172 includes a common UE radio capability for paging in the message in cases where the CU 172 determines to send the message for an MBS session. The common UE radio capability for paging includes one or more capabilities common for plural UEs.

FIG. 8 is a flow diagram of an example method 800 for paging UE(s) for an MBS. At block 802, the CU 172 receives, from a CN 110, a first message such as a CN-to-BS message, requesting MBS activation notification (e.g., events 306, 390, 406, 407). At block 804, the CU 172 generates a second message, such as a CU-to-DU message, for paging activation notification in response to the first message received from the CN 110. At block 806, the CU 172 determines whether the first message includes a paging DRX cycle configuration. If the first message includes a paging DRX cycle configuration, the flow proceeds to blocks 808 and 812. If the first message does not include a paging DRX cycle configuration, the flow proceeds to blocks 810 and 812. At block 808, the CU 172 includes a UE ID for a UE 102 (e.g., 5G-S-TMSI) and/or the first DRX cycle configuration in the second message. At block 810, the CU 172 includes a second DRX cycle configuration in the second message. At block 812, the CU 172 sends the second message to one or more DUs 174 (e.g., events 308, 390, 408, 458, 484, 409).

In some implementations, the first message includes one or more MBS session IDs and the CU 172 includes the one or more MBS session IDs in the second message. In further implementations, the CU 172 refrains from including a UE radio capability for paging in the second message. In other implementations, the CU 172 includes a common UE radio capability for paging in the second message. The common UE radio capability for paging includes one or more capabilities common for plural UEs.

In some implementations, the first message is an NGAP Paging message. In further implementations, the first paging DRX cycle configuration is an MBS (paging) DRX configuration or a grouping paging DRX cycle configuration. In other implementations, the first paging DRX cycle configuration is a UE specific DRX cycle configuration or a DRX cycle configuration for unicast paging. In some implementations, the second paging DRX cycle configuration is a RAN specific paging DRX cycle configuration. In other implementations, the second paging DRX cycle configuration is an MBS (paging) DRX configuration or a grouping paging DRX cycle configuration received from an OAM node. In yet other implementations, the second paging DRX cycle configuration is preconfigured in the CU 172.

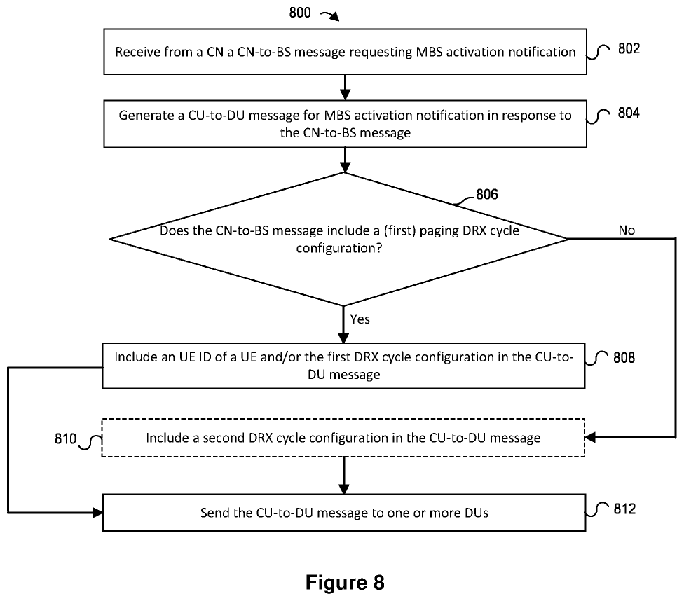

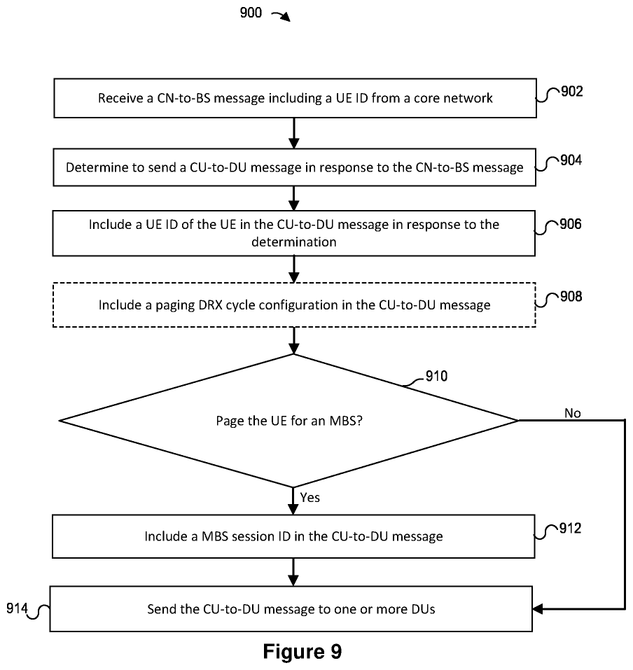

FIG. 9 is a flow diagram of an example method 900 for paging UE(s) for an MBS. At block 902, the CU 172 receives a first message from the CN 110, such as a CN-to-BS message, including a UE ID (e.g., events 306, 390, 406, 407). At block 904, the CU 172 determines to send a second message, such as a CU-to-DU message, in response to receiving the first message (e.g., events 308, 390, 408, 458, 484, 409). At block 906, the CU 172 includes a UE ID of the UE 102 in the second message in response to the determination (e.g., events 308, 390, 408, 458, 484, 409). In some implementations, at block 908, the CU 172 includes a paging DRX cycle configuration in the second message (e.g., events 308, 390, 408, 458, 484, 409). At block 910, the CU 172 determines whether to page the UE 102 for an MBS. If the CU 172 pages the UE 102 for an MBS, the flow proceeds to block 912. If the CU 172 pages the UE 102 for a service other than an MBS (e.g., a unicast service described above), the flow proceeds to block 914. At block 912, the CU 172 includes an MBS session ID in the second message (e.g., events 308, 390, 408, 458, 484, 409). At block 914, the CU 172 sends the second message to one or more DUs 174 (e.g., events 308, 390, 408, 458, 484, 409).

Blocks in FIGS. 10A-10B that are the same are labeled with the same reference numbers.

FIG. 10A is a flow diagram of an example method 1000A for paging UE(s) for an MBS. At block 1002, the DU 174 receives a first message, such as a CU-to-DU message, including one or more MBS session IDs from a CU 172 (e.g., events 308, 390, 408, 458, 484, 409). In some implementations, the first message includes one or more identifiers for one or more UEs 102. At block 1004, the DU 174 generates a paging message, including the one or more session IDs, in response to receiving the first message (e.g., events 310, 410, 460, 484). At block 1006, the DU 174 generates a DCI and a CRC for the DCI and scrambles the CRC with a P-RNTI to transmit the paging message (e.g., events 312, 412, 462). At block 1008, the DU 174 transmits the DCI and the scrambled CRC on a PDCCH to one or more UEs 102 in a first time instance (e.g., events 312, 412, 462). At block 1010, the DU 174 transmits the paging message to one or more UEs 102 in a second time instance later than the first time instance (e.g., events 312, 412, 462).

In some implementations, the first time instance and the second time instance can be the same slots or different slots. For example, the first time instance includes at least one first symbol (e.g., OFDM symbol(s)) and the second time instance includes at least one second symbol (e.g., OFDM symbol(s)). The at least one first symbol and the at least one second symbol can be in the same slot or different slots.

In some implementations where the first message includes at least one DRX cycle configuration, the DU 174 sends the DCI and the scrambled CRC on the PDCCH in one or more DRX cycles configured in the DRX cycle configuration.

In some implementations where the first message includes a UE radio capability for paging includes one or more capabilities, the DU 174 sends the DCI and the scrambled CRC on the PDCCH in accordance with the UE radio capability for paging.

FIG. 10B is a flow diagram of an example method 1000B for paging UE(s) for an MBS. At block 1002, the DU 174 receives a first message, such as a CU-to-DU message including one or more MBS session IDs from a CU 172 (e.g., events 308, 390, 408, 458, 484, 409). At block 1004, the DU 174 generates a paging message, including the one or more session IDs, for paging in response to receiving the first message (e.g., events 310, 410, 460). At block 1007, the DU 174 generates DCIs 1, . . . , N (N>=1) and CRCs 1, . . . , N for the DCIs 1, . . . , N and scramble the CRCs 1, . . . , N with a P-RNTI to transmit the paging message (e.g., events 312, 412, 462). At block 1009, the DU 174 transmits the DCIs 1, . . . , N, the scrambled CRCs 1, . . . , N on PDCCHs 1, . . . , N and the paging message to one or more UEs, on cells 1, . . . , N respectively (e.g., events 312, 412, 462).

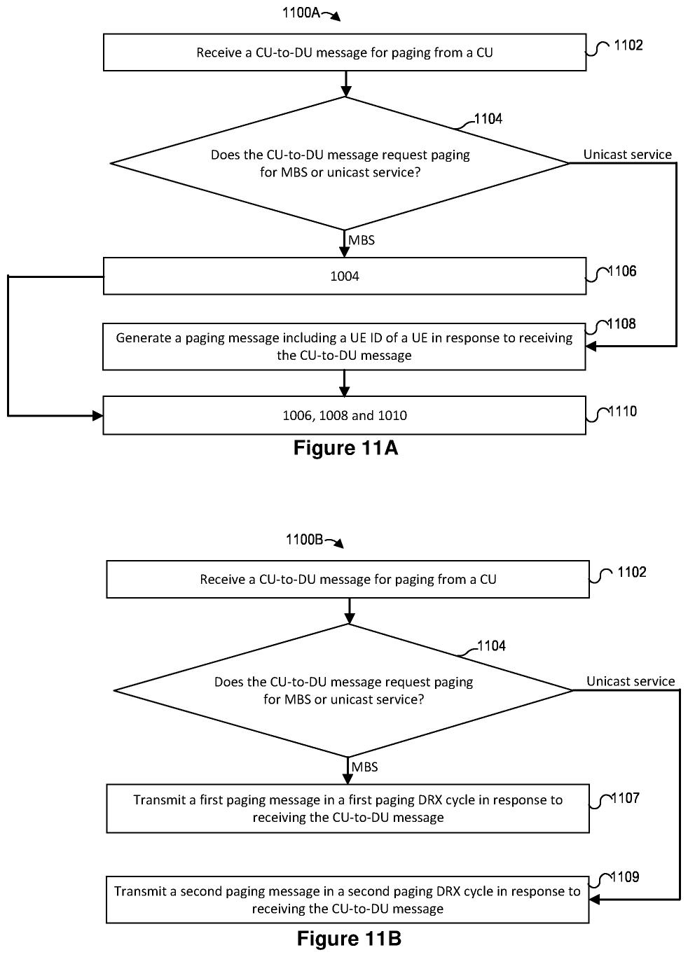

Blocks in FIGS. 11A-11B that are the same are labeled with the same reference numbers.

FIG. 11A is a flow diagram of an example method 1100A for paging UE(s) for an MBS. At block 1102, the DU 174 receives a message, such as a CU-to-DU message, for paging from a CU 172 (e.g., events 308, 390, 408, 458, 484, 409). At block 1104, the DU 174 determines whether the message requests paging for MBS or unicast service (e.g., as described above). If the message requests paging for an MBS, the flow proceeds to blocks 1004, 1006, 1008 and 1010 of FIG. 10A. If the message requests paging for a unicast service, the flow proceeds to blocks 1108 and blocks 1006, 1008 and 1010 of FIG. 10A. At block 1108, the DU 174 generates a paging message including a UE ID of a UE 102 (e.g., 5G-S-TMSI) in response to receiving the message.

In some implementations, the message can be a F1AP Paging message. In some implementations, the DU 174 at block 1110 transmits the DCI, the scrambled CRC, and/or the paging message in one or more paging occasions in one or more paging DRX cycles of a UE 102 in cases where the message requests paging for a unicast service. The DU 174 at block 1110 can refrain from transmitting the DCI, the scrambled CRC and/or the paging message in paging DRX cycle(s) of other UE(s) 102 to save power of the other UE(s) 102.

In other implementations, the DU 174 at block 1110 transmits the paging message in a paging occasion in an MBS paging DRX cycle, such as in cases where the message requests paging for an MBS. In yet other implementations, the DU 174 at block 1110 transmits the paging message across multiple paging DRX cycles of UEs 102, such as in cases where the message requests paging for an MBS. In some implementations, the DU 174 identifies or determines that the UEs 102 are UEs interested in receiving the MBS.

FIG. 11B is a flow diagram of an example method 1100B for paging UE(s) for an MBS. At block 1102, the DU 174 receives a message, such as a CU-to-DU message, for paging from a CU 172 (e.g., events 308, 390, 408, 458, 484, 409). At block 1104, the DU 174 determines whether the CU-to-DU message requests paging for MBS or unicast service (e.g., as described above). If the CU-to-DU message requests paging for an MBS, the flow proceeds to block 1107. If the CU-to-DU message requests paging for a unicast service, the flow proceeds to block 1109. At block 1107, the DU 174 transmits a first paging message in a first paging DRX cycle in response to receiving the CU-to-DU message (e.g., events 312, 412, 462). At block 1109, the DU 174 transmits a second paging message in a second paging DRX cycle in response to receiving the CU-to-DU message.

The first and second paging DRX cycles can be similar to the examples and implementations described for FIG. 8. As such, particular implementations for FIG. 8 also apply to FIGS. 11A and 11B where relevant.

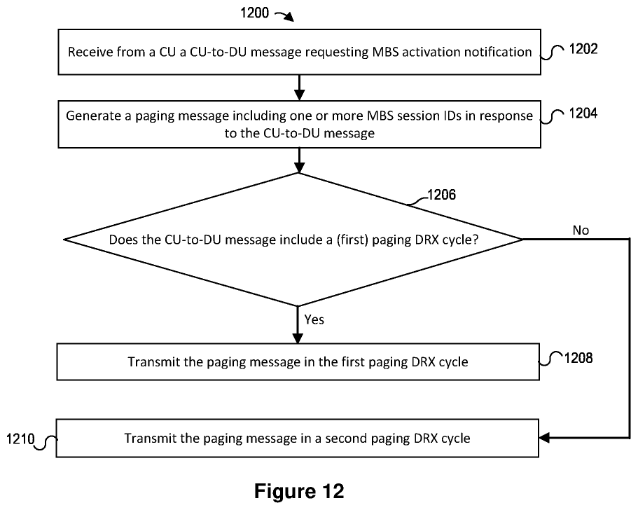

FIG. 12 is a flow diagram of an example method 1200 for paging UE(s) for an MBS. At block 1202, the DU 174 receives a first message from a CU 172, such as a CU-to-DU message, requesting MBS activation notification (e.g., events 308, 390, 408, 458, 484, 409). At block 1204, the DU 174 generates a paging message including one or more MBS session IDs in response to the first message (e.g., events 312, 412, 462). At block 1206, the DU 174 determines whether the first message includes a paging DRX cycle. If the first message includes a paging DRX cycle, the flow proceeds to block 1208. If the first message does not include a paging DRX cycle, the flow proceeds to block 1210. At block 1208, the DU 174 transmits the paging message in the first paging DRX cycle. At block 1210, the DU 174 transmits the paging message in a second paging DRX cycle.

The first and second paging DRX cycles can be similar to the examples and implementations described for FIG. 8. As such, particular implementations for FIG. 8 also apply to FIG. 12 where relevant.

In some implementations, the first message is a F1AP Paging message. In further implementations, to transmit the paging message, the DU 174 generates a DCI and a CRC for the DCI and scrambles the CRC with a P-RNTI. The DU 174 at block 1208 transmits the DCI, the scrambled CRC, and/or the paging message (in one or more paging occasions) in an on-duration (e.g., paging occasion(s)) of a first DRX cycle (e.g., paging DRX cycle or unicast paging DRX cycle). In other implementations, the DU 174 at block 1208 refrains from transmitting the DCI, the scrambled CRC, and/or the paging message in paging DRX cycle(s) of other UE(s) to save power of the other UE(s).

In other implementations, the DU 174 at block 1210 transmits the DCI, the scrambled CRC, and/or the paging message in an on-duration of a second DRX cycle (e.g., MBS DRX cycle or MBS paging DRX cycle). In yet other implementations, the DU 174 at block 1210 transmits the paging message across multiple DRX cycles of UEs 102. In some implementations, the DU 174 identifies or determines that the UEs 102 are UEs interested in receiving the MBS.

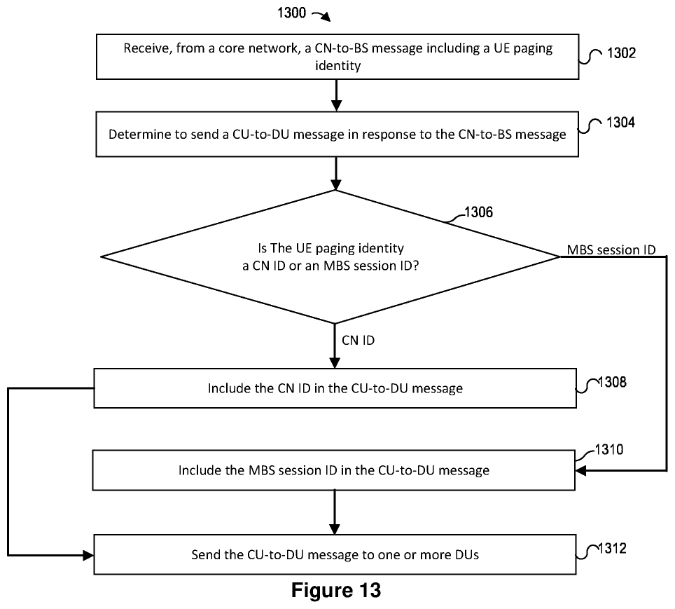

FIG. 13 is a flow diagram of an example method 1300 for paging UE(s) for an MBS. At block 1302, the CU 172 receives, from a CN 110, a first message such as a CN-to-BS message including a UE paging identity (e.g., events 306, 390, 406, 407). At block 1304, the CU 172 determines to send a second message to the DU(s) 174 in response to the first message (e.g., events 308, 390, 408, 458, 484, 409). At block 1306, the CU 172 determines whether the UE paging identity is a CN ID or an MBS session ID. If the UE paging identity is a CN ID (e.g., 5G-S-TMSI), the flow proceeds to blocks 1308 and 1312. If the UE paging identity is an MBS session ID, the flow proceeds to blocks 1310 and 1312. At block 1308, the CU 172 includes the CN ID in the second message (e.g., events 308, 390, 408, 458, 484, 409). At block 1310, the CU 172 includes the MBS session ID in the second message (e.g., events 308, 390, 408, 458, 484, 409). At block 1312, the CU 172 sends the second message to one or more DUs 174.

In some implementations, the first message is an NGAP Paging message or an interface message for 6G (e.g., 6G application protocol (6GAP) message). In further implementations, the second message is an F1AP paging message indicating to the one or more DUs 174 to page one or more UEs 102. For example, the second message can be a Paging message defined in 3GPP specifications 38.473.

In some implementations, the CU 172 determines that the UE paging identity is an MBS session ID if the first message includes an indication indicating that UE paging identity is an MBS session ID. If the first message does not include the indication, the CU 172 can determine that the UE paging identity is a CN ID.

In some implementations, the CU 172 includes the MBS session ID or the CN ID in a UE paging identity IE of the second message. In some such cases, the CU 172 includes an indication in the second message to indicate that the UE paging identity is an MBS session ID, such as in cases where the CU 172 determines that the UE paging identity is an MBS session ID. The CU 172 can exclude the indication in the second message to indicate that the UE paging identity is a CN ID, such as in cases where the CU 172 determines that the UE paging identity is a CN ID.

Blocks in FIGS. 14A-14B that are the same are labeled with the same reference numbers.

FIG. 14A is a flow diagram of an example method 1400A for paging UE(s) for an MBS. At block 1402, a RAN (e.g., the RAN 105) receives from a CN 110 a first message, such as a CN-to-BS message, including a UE ID, a paging DRX cycle configuration and an MBS session ID (e.g., events 406, 407). At block 1404, the RAN 105 determines paging occasion(s) in accordance with the UE ID and the paging DRX cycle configuration. At block 1406, the RAN 105 generates a paging message including the MBS session ID (e.g., events 410, 460). At block 1408, the RAN 105 generates a DCI to transmit the paging message. At block 1410, the RAN 105 transmits the DCI on a PDCCH in the paging occasion(s) on one or more cells (e.g., events 412, 462). At block 1412, the RAN 105 transmits the paging message on the one or more cells (e.g., events 412, 462).

In some implementations, the RAN 105 refrains from including the UE ID in the paging message. Alternatively, the RAN 105 includes the UE ID in the paging message.

FIG. 14B is a flow diagram of an example method 1400B for paging UE(s) for an MBS. At block 1402, the RAN 105 receives, from a CN 110, a first message such as a CN-to-BS message, including a UE ID, a paging DRX cycle configuration, and an MBS session ID. At block 1405, the RAN 105 determines a paging occasion(s) in accordance with the MBS session ID and the paging DRX cycle configuration. At block 1406, the RAN 105 generates a paging message including the UE ID and the MBS session ID. At block 1408, the RAN 105 generates a DCI to transmit the paging message. At block 1410, the RAN 105 transmits the DCI on a PDCCH in the paging occasion(s) on one or more cells. At block 1412, the RAN transmits the paging message on the one or more cells.

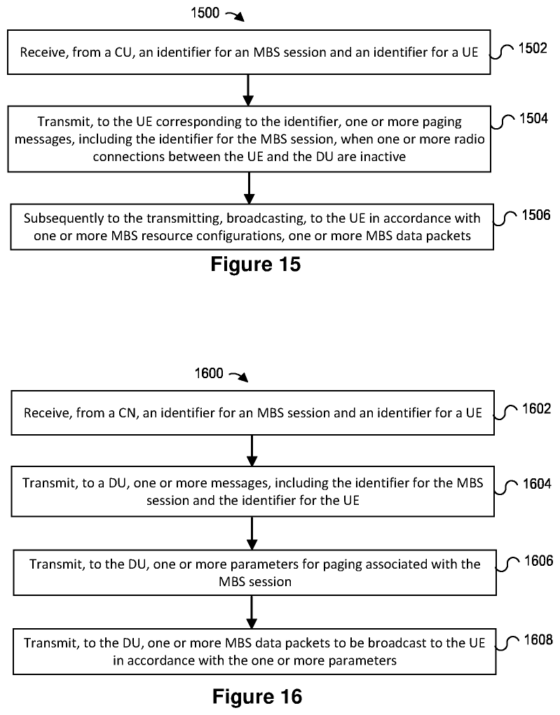

FIG. 15 is a flow diagram of an example method 1500 for managing paging for multicast and broadcast services, implemented in a DU. At block 1502, the DU 174 receives, from a CU 172, an identifier for an MBS session and an identifier for a UE 102 (e.g., events 308, 408, 409, and 458 and blocks 1002, 1102, and 1202 of FIGS. 3A-4C and 10A-12). At block 1504, the DU 174 transmits, to the UE 102, corresponding to the identifier, one or more paging messages, including the identifier for the MBS session, when one or more radio connections between the UE 102 and the DU 174 are inactive (e.g., events 312, 412, and 462 and blocks 1004/1010, 1106/1107/1108/1109/1110, and 1204/1208/1210 of FIGS. 3A-4C and 10-12). At block 1506, the DU 174, subsequently to the transmitting, broadcasts, to the UE 102 in accordance with one or more MBS resource configurations, one or more MBS data packets (e.g., events 332, 431, and 432 of FIGS. 3A-4C).

FIG. 16 is a flow diagram of an example method 1600 for managing paging for multicast and broadcast services, implemented in a CU. At block 1602, the CU 172 receives, from a CN 110, an identifier for an MBS session and an identifier for a UE 102 (e.g., events 306, 406, and 456 and blocks 502, 802, 902, and 1302 of FIGS. 3A-5, 8, 9, and 13). At block 1604, the CU 172 transmits, to a DU 174, one or more messages, including the identifier for the MBS session and the identifier for the UE 102 (e.g., events 308, 408, 409, and 458 and blocks 504/508, 606/610, 612/616, 706/710/714, 808/812, 906/912/914, and 1310/1312 of FIGS. 3A-9 and 13). At block 1606, the CU 172 transmits, to the DU 174, one or more parameters for paging associated with the MBS session (e.g., events 318, 408, 409, and 458 and blocks 506/508, 608/610, 614/616, 708/712/714, 810/812, 908/914, 1308/1312). At block 1608, the CU 172 transmits, to the DU 174, one or more MBS data packets to be broadcast to the UE 102 in accordance with the one or more parameters (e.g., events 330/430 of FIGS. 3A-4C).

The following list of examples reflects a variety of the embodiments explicitly contemplated by the present disclosure:

Example 1. A method for managing paging for multicast and broadcast services (MBS), the method implemented in a central unit (CU) of a distributed base station and comprising: receiving, at the CU from a core network (CN), an identifier for an MBS session and an identifier for a user equipment (UE); transmitting, to a distributed unit (DU) of the distributed base station, (i) the identifier for the MBS session, (ii) the identifier for the UE, and (iii) one or more parameters for paging associated with the MBS session; and transmitting, to the DU, one or more MBS data packets to be broadcast to the UE in accordance with the one or more parameters.

Example 2. The method of example 1, further comprising: receiving, from the CN, a message including at least the identifier for the MBS session and the one or more parameters for paging; generating one or more MBS resource configurations based on at least the one or more parameters for paging; and transmitting the one or more MBS resource configurations to the DU.

Example 3. The method of example 1, further comprising: transmitting, to each of a plurality of UEs, a respective message including the identifier for the MBS session and a respective identifier of the UE of the plurality of UEs.

Example 4. The method of example 1, further comprising: transmitting, to a plurality of UEs, a shared message including the identifier for the MBS session and a listing of respective identifiers of the plurality of UEs.

Example 5. The method of example 3 or 4, further comprising: receiving, from the CN, a plurality of CN messages, each of the plurality of CN messages including the identifier for the MBS session and a respective identifier for a UE of the plurality of UEs.

Example 6. The method of example 3 or 4, further comprising: receiving, from the CN, a shared CN message including the identifier for the MBS session and a listing of respective identifiers for the plurality of UEs.

Example 7. The method of any of examples 1-6, wherein transmitting the identifier for the MBS session is in response to determining that the DU pages the UE for the MBS session.

Example 8. The method of any of examples 1-7, wherein the one or more parameters includes at least one of: a paging cycle configuration for the MBS session, or one or more paging cycle configurations for the UE.

Example 9. The method of example 8, further comprising: determining a paging period in accordance with the paging cycle configuration and at least one of an identifier for the UE or the identifier for the MBS session; generating a paging message including the identifier for the MBS session and the identifier for the UE; and transmitting information about the paging period and the paging message to the DU.

Example 10. A method for managing paging for multicast and broadcast services (MBS), the method implemented in a distributed unit (DU) of a distributed base station and comprising: receiving, from a central unit (CU) of the distributed base station, an identifier for an MBS session and an identifier for a user equipment (UE); transmitting, to the UE, a paging message including the identifier for the MBS session; and subsequently to the transmitting, broadcasting, to the UE in accordance with one or more MBS resource configurations, one or more MBS data packets.

Example 11. The method of example 10, wherein transmitting the paging message is in accordance with at least one of: a paging cycle configuration of the MBS session, or a paging cycle configuration of the UE.

Example 12. The method of example 10, further comprising: transmitting, for each of a plurality of UEs, a respective paging message including the identifier for the MBS session.

Example 13. The method of example 12, wherein transmitting the paging messages includes: transmitting a first subset of the paging messages in accordance with a paging cycle of the MBS session; and transmitting a second subset of the paging messages in accordance with a respective paging cycle of the corresponding UE of the plurality of UEs.

Example 14. The method of any of examples 10-13, wherein the identifier for the MBS session includes a Temporary Mobile Group Identity (TMGI).

Example 15. An apparatus comprising processing hardware and configured to implement a method according to any of examples 1-14.

Example 16. The method of example 10, further comprising: broadcasting the one or more MBS resource configurations to the UE using the identifier for the MBS session; wherein broadcasting the one or more MBS data packets is subsequent to broadcasting the one or more MBS resource configurations.

Example 17. The method of example 11, wherein receiving the identifier for the MBS session and the identifier for the UE includes: receiving a message from the CU, the message including the identifier for the first UE and the identifier for the second UE.

Example 18. The method of example 11, wherein receiving the identifier for the MBS session and the identifier for the UE includes: receiving a first message from the CU including the identifier for the first UE; and receiving a second message from the CU including the identifier for the second UE.

Example 19. The method of example 10, wherein the UE is a first UE of a plurality of UEs and transmitting the one or more paging messages includes: transmitting a first paging message of the one or more paging messages to the first UE in accordance with a paging cycle of the first UE; and transmitting a second paging message of the one or more paging messages to a second UE in accordance with a paging cycle of the second UE.

Example 20. The method of example 10, further comprising: generating a downlink control information set and a cycle error check algorithm; generating a secured error check algorithm by applying a security protocol to the cycle error check algorithm; and transmitting the downlink control information and the secured error check algorithm to the UE.

Example 21. The method of example 20, wherein the DU transmits the downlink control information and the secured error check algorithm to the UE during a first paging period and transmits a paging message to the UE during a second paging period.

Example 22. The method of example 20 or 21, wherein: the UE is a first UE of a plurality of UEs; the downlink control information is a plurality of downlink control information sets; the cycle error check algorithm is a plurality of cycle error check algorithms equal in number to the plurality of downlink control information sets; and transmitting the paging message to the first UE is over a plurality of cells equal in number to the plurality of downlink control information sets.

Example 23. The method of example 10, further comprising: receiving, from the CU, a message for paging; and determining whether to generate a first paging message for the UE including the identifier for the MBS session or a second paging message for the UE including an identifier of the UE based on whether the message for paging requests MBS or unicast service.

Example 24. The method of example 10, further comprising: receiving, from the CU, a message for paging; and determining whether to transmit a first paging message in accordance with a paging cycle configuration for the MBS session or a second paging message in accordance with a paging cycle configuration for the UE based on whether the message for paging requests MBS or unicast service.

Example 25. The method of example 10, further comprising: receiving, from the CU, a message requesting activation of the MBS session; and determining whether to transmit a paging message to the DU in accordance with a first paging cycle configuration or a second paging cycle configuration based on whether the message requesting activation includes the first paging cycle configuration.

Example 26. The method of example 1, wherein the DU is a first DU and further comprising: determining to page for a service; determining whether to transmit, to the first DU, a first message including an MBS session identifier or a second message including a UE identifier for the UE to a second DU based on whether the service is an MBS service or a unicast service.

Example 27. The method of example 26, further comprising: including, in the first message, an MBS paging cycle configuration in the first message.

Example 28. The method of example 26, further comprising: including, in the second message, a UE paging cycle configuration for the UE in the second message.

Example 29. The method of example 1, further comprising: receiving, from the CN, a first message including a request to activate the MBS session; generating a second message to transmit to the DU to activate the MBS session; and determining whether to include an identifier for a UE in the second message based on whether the first message includes a paging cycle configuration.

Example 30. The method of example 29, wherein the paging cycle configuration is a first paging cycle configuration and further comprising: determining whether to include the first paging cycle configuration or a second paging cycle configuration in the second message based on whether the first message includes the first paging cycle configuration.

Example 31. The method of example 1, further comprising: receiving, from the CN, a message including a UE paging identity; and determining whether to transmit a message including an identifier for the CN or the identifier for the MBS session based on whether the UE paging identity is the identifier for the CN or the identifier for the MBS session.

Example 32. The method of example 31, wherein: the UE paging identity is the identifier for the MBS session when the message including the UE paging identity incudes an indication that the UE paging identity is the identifier for the MBS session; and the UE paging identity is the identifier for the CN when the message including the UE paging identity does not include the indication that the UE paging identity is the identifier for the MBS session.

Example 33. An apparatus comprising processing hardware and configured to implement a method according to any of examples 16-32.

The following additional considerations apply to the foregoing discussion.

In some implementations, the UE can receive data of an MBS in a broadcast session without performing a session join procedure for receiving the MBS. That is, the UE does not need to perform a session join procedure for a broadcast session. In other implementations, the UE can receive data of an MBS in a broadcast session in accordance with configuration parameters broadcast by the RAN, i.e., without performing a RRC reconfiguration procedure to receive configuration parameters to receive data of the MBS.

In some implementations, the UE has to perform a session join procedure to receive data of an MBS in a multicast session. In other implementations, the UE can only receive data of an MBS in a multicast session in accordance with configuration parameters received in a RRC reconfiguration message.

In some implementations, “MBS” can be replaced by “MBS session” or vice versa. In some implementations, “message” is used and can be replaced by “information element (IE)”. In some implementations, “IE” is used and can be replaced by “field”. In some implementations, “configuration” can be replaced by “configurations” or the configuration parameters. In some implementations, the “MBS session ID” can be replaced by the “MBS session IDs” and the “MBS session” can be replaced by “MBS sessions”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method for managing paging for multicast and broadcast services (MBS), the method implemented in a central unit (CU) of a distributed base station and comprising:
receiving, at the CU from a core network (CN), an identifier for an MBS session and an identifier for a user equipment (UE);
transmitting, to a distributed unit (DU) of the distributed base station, (i) the identifier for the MBS session, (ii) the identifier for the UE, and (iii) one or more parameters for paging associated with the MBS session; and
transmitting, to the DU, one or more MBS data packets to be broadcast to the UE in accordance with the one or more parameters.

2. The method of claim 1, further comprising:
receiving, from the CN, a message including at least the identifier for the MBS session and the one or more parameters for paging;
generating one or more MBS resource configurations based on at least the one or more parameters for paging; and
transmitting the one or more MBS resource configurations to the DU.

3. The method of claim 1, further comprising:
transmitting, to each of a plurality of UEs, a respective message including the identifier for the MBS session and a respective identifier of the UE of the plurality of UEs.

4. The method of claim 1, further comprising:
transmitting, to a plurality of UEs, a shared message including the identifier for the MBS session and a listing of respective identifiers of the plurality of UEs.

5. The method of claim 3, further comprising:
receiving, from the CN, a plurality of CN messages, each of the plurality of CN messages including the identifier for the MBS session and a respective identifier for a UE of the plurality of UEs.

6. The method of claim 3, further comprising:
receiving, from the CN, a shared CN message including the identifier for the MBS session and a listing of respective identifiers for the plurality of UEs.

7. The method of claim 1, wherein transmitting the identifier for the MBS session is in response to determining that the DU pages the UE for the MBS session.

8. The method of claim 1, wherein the one or more parameters includes at least one of:
a paging cycle configuration for the MBS session, or
one or more paging cycle configurations for the UE.

9. The method of claim 8, further comprising:
determining a paging period in accordance with the paging cycle configuration and at least one of an identifier for the UE or the identifier for the MBS session;
generating a paging message including the identifier for the MBS session and the identifier for the UE; and
transmitting information about the paging period and the paging message to the DU.

10. A method for managing paging for multicast and broadcast services (MBS), the method implemented in a distributed unit (DU) of a distributed base station and comprising:
receiving, from a central unit (CU) of the distributed base station, an identifier for an MBS session and an identifier for a user equipment (UE);
transmitting, to the UE, a paging message including the identifier for the MBS session; and
subsequently to the transmitting, broadcasting, to the UE in accordance with one or more MBS resource configurations, one or more MBS data packets.

11. The method of claim 10, wherein transmitting the paging message is in accordance with at least one of:
a paging cycle configuration of the MBS session, or
a paging cycle configuration of the UE.

12. The method of claim 10, further comprising:
transmitting, for each of a plurality of UEs, a respective paging message including the identifier for the MBS session.

13. The method of claim 12, wherein transmitting the paging messages includes:
transmitting a first subset of the paging messages in accordance with a paging cycle of the MBS session; and
transmitting a second subset of the paging messages in accordance with a respective paging cycle of the corresponding UE of the plurality of UEs.

14. The method of claim 10, wherein the identifier for the MBS session includes a Temporary Mobile Group Identity (TMGI).

15. An apparatus, operating as a central unit (CU) of a distributed base station and configured for managing paging for multicast and broadcast services (MBS), the apparatus comprising:
processing hardware configured to:
receive, at the CU from a core network (CN), an identifier for an MBS session and an identifier for a user equipment (UE);
transmit, to a distributed unit (DU) of the distributed base station, (i) the identifier for the MBS session, (ii) the identifier for the UE, and (iii) one or more parameters for paging associated with the MBS session; and
transmit, to the DU, one or more MBS data packets to be broadcast to the UE in accordance with the one or more parameters.

16. The apparatus of claim 15, wherein the processing hardware is further configured to:
receive, from the CN, a message including at least the identifier for the MBS session and the one or more parameters for paging;
generate one or more MBS resource configurations based on at least the one or more parameters for paging; and
transmit the one or more MBS resource configurations to the DU.

17. The apparatus of claim 15, wherein the processing hardware is further configured to:
transmit, to each of a plurality of UEs, a respective message including the identifier for the MBS session and a respective identifier of the UE of the plurality of UEs.

18. The apparatus of claim 15, wherein the processing hardware is further configured to:
transmit, to a plurality of UEs, a shared message including the identifier for the MBS session and a listing of respective identifiers of the plurality of UEs.

19. The apparatus of claim 15, wherein transmitting the identifier for the MBS session is in response to determining that the DU pages the UE for the MBS session.

20. The apparatus of claim 15, wherein the one or more parameters includes at least one of:
a paging cycle configuration for the MBS session, or
one or more paging cycle configurations for the UE.
